(19) United States
(12) Patent Application Publication
(10) Pub. No.: US 2025/0264496 A1
(43) Pub. Date: Aug. 21, 2025

(54) SENSOR AND ELECTRONIC DEVICE

(71) Applicant: KABUSHIKI KAISHA TOSHIBA, Tokyo (JP)

(72) Inventors: Kei MASUNISHI, Kawasaki Kanagawa (JP); Etsuji OGAWA, Kawasaki Kanagawa (JP); Yasushi TOMIZAWA, Fuchu Tokyo (JP); Fumitaka ISHIBASHI, Kawasaki Kanagawa (JP); Hideaki MURASE, Yokohama Kanagawa (JP); Kengo UCHIDA, Kawasaki Kanagawa (JP); Fumito MIYAZAKI, Yokohama Kanagawa (JP); Daiki ONO, Yokohama Kanagawa (JP); Jumpei OGAWA, Kawasaki Kanagawa (JP)

(73) Assignee: KABUSHIKI KAISHA TOSHIBA, Tokyo (JP)

(21) Appl. No.: 19/004,609

(22) Filed: Dec. 30, 2024

(30) Foreign Application Priority Data
Feb. 21, 2024 (JP) 2024-024740

(51) Int. Cl. G01P 15/135; G01P 15/125

(52) U.S. Cl. CPC G01P 15/135; G01P 15/125

(57) ABSTRACT

According to one embodiment, a sensor includes a base and an element section. The element section includes a first fixed portion fixed to the base, a first fixed electrode fixed to the base, and a first movable portion. A first gap is provided between the base and the first movable portion. The first movable portion includes a first movable base portion supported by the first fixed portion, a first other movable base portion connected to the first movable base portion, and a first movable structure. The first movable structure includes a first beam, a first movable electrode, and a first connecting portion. The first beam include a first beam portion, a first other beam portion, and a first intermediate beam portion between the first beam portion and the first other beam portion.

### CROSS-REFERENCE TO RELATED APPLICATIONS

This application is based upon and claims the benefit of priority from Japanese Patent Application No. 2024-024740, filed on Feb. 21, 2024; the entire contents of which are incorporated herein by reference.

### FIELD

Embodiments described herein relate generally to a sensor and an electronic device.

### BACKGROUND

For example, there are sensors that utilize a MEMS structure. Stable characteristics are desired in sensors.

### BRIEF DESCRIPTION OF THE DRAWINGS

FIGS. 1A and 1B are schematic plan views illustrating a part of the sensor according to a first embodiment;

FIG. 2 is a schematic plan view illustrating the sensor according to the first embodiment;

FIGS. 3A to 3C are schematic cross-sectional views illustrating the sensor according to the first embodiment;

FIG. 4 is a schematic cross-sectional view illustrating the sensor according to the first embodiment;

FIGS. 5A and 5B are schematic views illustrating the sensor according to the first embodiment;

FIG. 6 is a graph illustrating the characteristics of the sensor according to the first embodiment;

FIGS. 7A and 7B are schematic plan views illustrating a part of a sensor according to the first embodiment;

FIGS. 8A and 8B are schematic plan views illustrating a part of a sensor according to the first embodiment;

FIGS. 9A and 9B are schematic plan views illustrating a part of a sensor according to the first embodiment;

FIGS. 10A and 10B are schematic plan views illustrating a part of a sensor according to the first embodiment;

FIGS. 11A and 11B are schematic plan views illustrating a part of a sensor according to the first embodiment;

FIGS. 12A and 12B are schematic plan views illustrating a part of a sensor according to the first embodiment;

FIGS. 13A and 13B are schematic plan views illustrating a part of a sensor according to the first embodiment;

FIGS. 14A and 14B are schematic plan views illustrating a part of a sensor according to the first embodiment;

FIG. 15 is a schematic plan view illustrating a part of a sensor according to the first embodiment;

FIGS. 16A and 16B are schematic plan views illustrating a part of a sensor according to the first embodiment;

FIG. 17 is a schematic plan views illustrating the sensor according to the first embodiment;

FIG. 18 is a schematic plan views illustrating the sensor according to the first embodiment;

FIG. 19 is a schematic plan views illustrating the sensor according to the first embodiment;

FIG. 20 is a schematic plan views illustrating the sensor according to the first embodiment;

FIG. 21 is a schematic plan views illustrating the sensor according to the first embodiment;

FIG. 22 is a schematic plan views illustrating the sensor according to the first embodiment;

FIG. 23 is a schematic plan views illustrating the sensor according to the first embodiment;

FIG. 24 is a schematic plan views illustrating the sensor according to the first embodiment;

FIG. 25 is a schematic plan views illustrating the sensor according to the first embodiment;

FIG. 26 is a schematic plan views illustrating the sensor according to the first embodiment;

FIG. 27 is a schematic plan views illustrating the sensor according to the first embodiment;

FIG. 28 is a schematic plan views illustrating the sensor according to the first embodiment;

FIG. 29 is a schematic plan views illustrating the sensor according to the first embodiment;

FIG. 30 is a schematic diagram illustrating an electronic device according to the second embodiment;

FIGS. 31A to 31H are schematic diagrams illustrating applications of the electronic device according to the embodiment; and

FIGS. 32A and 32B are schematic diagrams illustrating applications of the sensor according to the embodiment.

### DETAILED DESCRIPTION

According to one embodiment, a sensor includes a base and an element section. The element section includes a first fixed portion fixed to the base, a first fixed electrode fixed to the base, and a first movable portion. A first gap is provided between the base and the first movable portion. The first movable portion includes a first movable base portion supported by the first fixed portion, a first other movable base portion connected to the first movable base portion, and a first movable structure. The first movable structure includes a first beam, a first movable electrode, and a first connecting portion. The first beam include a first beam portion, a first other beam portion, and a first intermediate beam portion between the first beam portion and the first other beam portion. A second direction from the first beam portion to the first other beam portion crosses a first direction from the base to the first fixed portion. The first beam portion is connected to the first movable base portion. The first other beam portion is connected to the first other movable base portion. A third direction from the first beam to the first movable electrode crosses a plane including the first direction and the second direction. The first connecting portion connects the first movable electrode to the first intermediate beam portion. The first movable electrode includes a first movable electrode base portion and a plurality of first movable protruding portions connected to the first movable electrode base portion. The plurality of first movable protruding portions are arranged along the second direction. The first fixed electrode includes a first fixed electrode base portion and a plurality of first fixed protruding portions connected to the first fixed electrode base portion. The plurality of first fixed protruding portion are arranged along the second direction. The plurality of first movable protruding portions meshes with the plurality of first fixed protruding portions in a comb-teeth shape. The plurality of first movable protruding portions include a first movable end protruding portions, a first movable other end protruding portion, and a plurality of first movable intermediate protruding portions. The first movable end protruding portion is one end in the second direction among the plurality of first movable protruding portions. The first movable other end protruding portion being another end in the second direction among the plurality of first movable protruding portions. The plurality of first movable intermediate protruding portions are between the first movable end protruding portion and the first movable other end protruding portion. A first movable end protruding portion width of the first movable end protruding portion along the second direction is the same as a first movable other end protruding portion width of the first movable other end protruding portion along the second direction.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

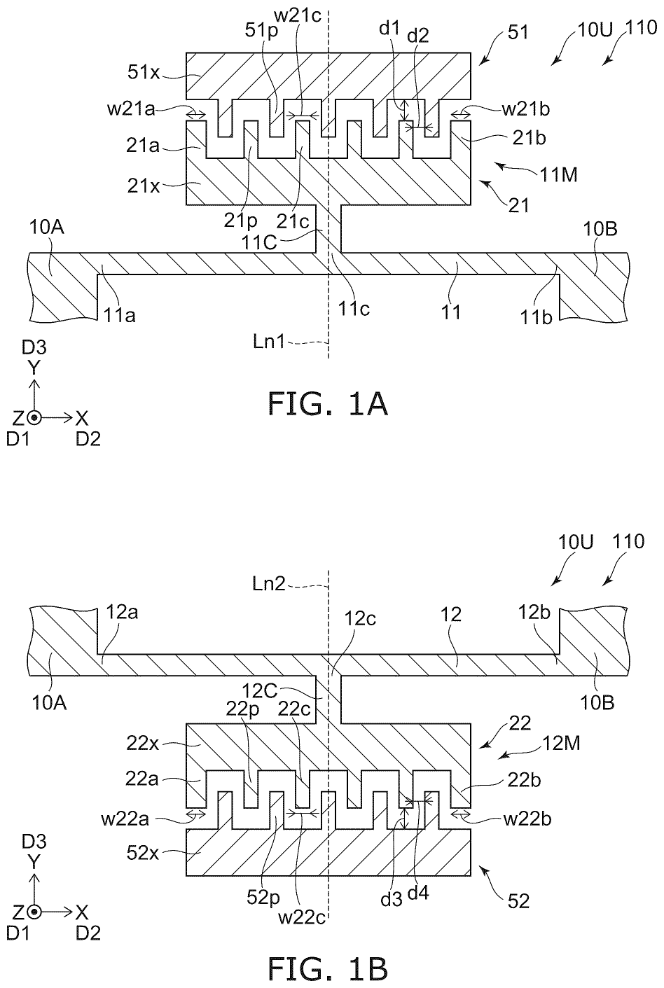

FIGS. 1A and 1B are schematic plan views illustrating a part of the sensor according to a first embodiment.

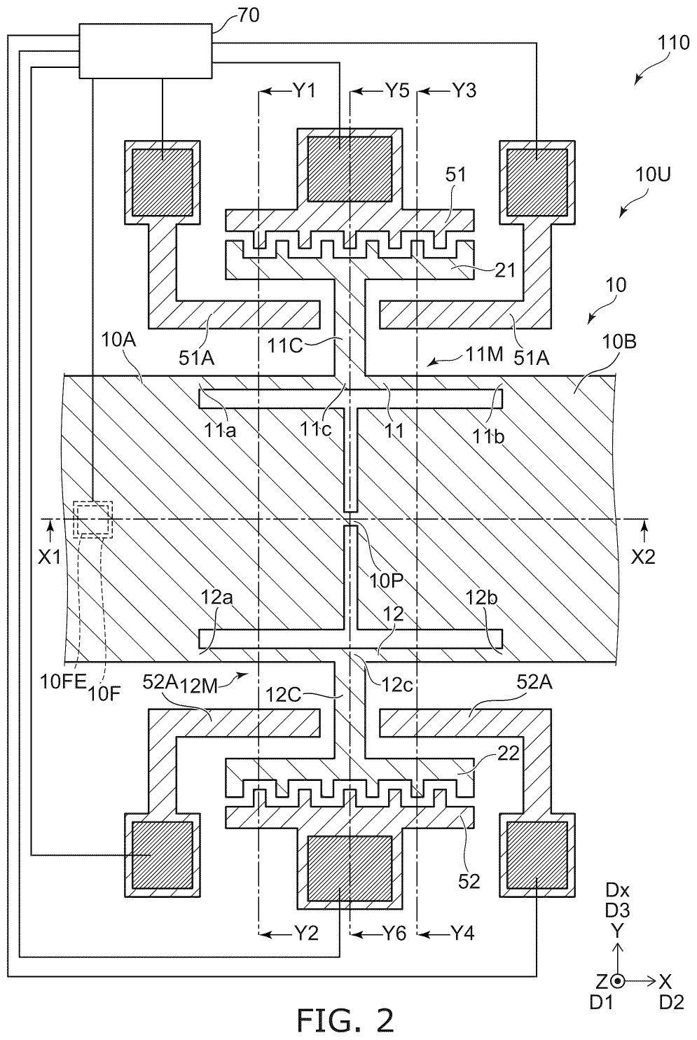

FIG. 2 is a schematic plan view illustrating the sensor according to the first embodiment.

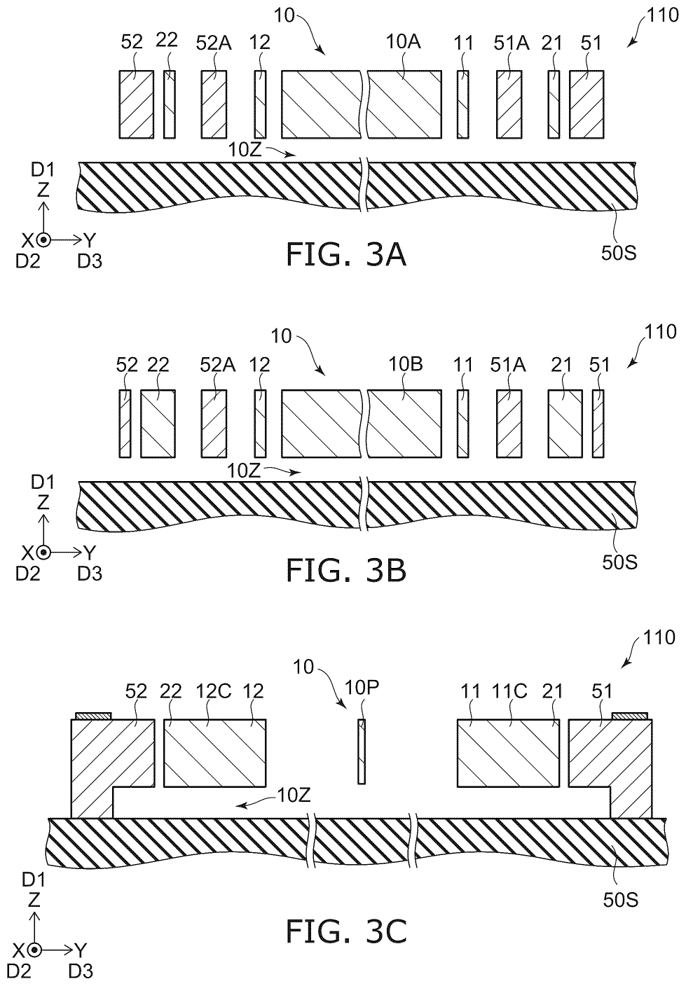

FIGS. 3A to 3C are schematic cross-sectional views illustrating the sensor according to the first embodiment.

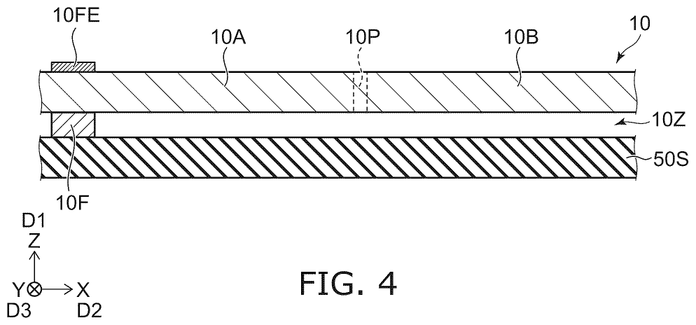

FIG. 4 is a schematic cross-sectional view illustrating the sensor according to the first embodiment.

FIG. 3A is a cross-sectional view taken along the line Y1-Y2 in FIG. 2. FIG. 3B is a sectional view taken along the line Y3-Y4 in FIG. 2. FIG. 3C is a sectional view taken along the line Y5-Y6 in FIG. 2. FIG. 4 is a sectional view taken along the line X1-X2 in FIG. 2.

As shown in FIGS. 2, 3A to 3C, and FIG. 4, a sensor 110 according to the embodiment includes a base 50S and an element section 10U. The element section 10U includes a first fixed portion 10F fixed to the base 50S, a first fixed electrode 51 fixed to the base 50S, and a first movable portion 10. A first gap 10Z is provided between the base 50S and the first movable portion 10.

The first movable portion 10 includes a first movable base portion 10A supported by the first fixed portion 10F, a first other movable base portion 10B connected to the first movable base portion 10A, and a first movable structure 11M.

The first movable structure 11M includes a first beam 11, a first movable electrode 21, and a first connecting portion 11C. The first beam 11 includes a first beam portion 11a, a first other beam portion 11b, and a first intermediate beam portion 11c. The first intermediate beam portion 11c is provided between the first beam portion 11a and the first other beam portion 11b.

A second direction D2 from the first beam portion 11a to the first other beam portion 11b crosses a first direction D1 from the base 50S to the first fixed portion 10F. The first direction D1 is defined as a Z-axis direction. One direction perpendicular to the Z-axis direction is defined as an X-axis direction. A direction perpendicular to the Z-axis direction and the X-axis direction is defined as a Y-axis direction. The second direction D2 may be, for example, the X-axis direction.

The first beam 11 extends, for example, along the second direction D2. The first beam portion 11a is connected to the first movable base portion 10A. The first other beam portion 11b is connected to the first other movable base portion 10B.

In this example, the first movable portion 10 further includes a first movable connecting portion 10P. The first movable connecting portion 10P is provided between the first movable base portion 10A and the first other movable base portion 10B. The first movable connecting portion 10P is connected to the first movable base portion 10A and the first other movable base portion 10B. A direction crossing a direction from the first movable base portion 10A to the first other movable base portion 10B is defined as a cross direction Dx (see FIG. 2). The cross direction Dx crosses the first direction D1. The cross direction Dx is, for example, the Y-axis direction. A width of the first movable connecting portion 10P in the cross direction Dx is narrower than a width of the first movable base portion 10A in the cross direction Dx, and narrower than a width of the first other movable base portion 10B in the cross direction Dx.

A third direction D3 from the first beam 11 to the first movable electrode 21 crosses a plane including the first direction D1 and the second direction D2. The third direction D3 may be, for example, the Y-axis direction. The cross direction Dx may be substantially parallel to the third direction D3.

The first connecting portion 11C connects the first movable electrode 21 to the first intermediate beam portion 11c. The first connecting portion 11C extends, for example, along the third direction D3.

FIG. 1A illustrates the first movable electrode 21 and the first fixed electrode 51. The first movable electrode 21 includes a first movable electrode base portion 21x and a plurality of first movable protruding portions 21p. The plurality of first movable protruding portions 21p are connected to the first movable electrode base portion 21x. The plurality of first movable protruding portions 21p are arranged along the second direction D2.

As shown in FIG. 1A, the first fixed electrode 51 includes a first fixed electrode base portion 51x and a plurality of first fixed protruding portions 51p. The plurality of first fixed protruding portions 51p are connected to the first fixed electrode base portion 51x and arranged along the second direction D2. The plurality of first movable protruding portions 21p mesh with the plurality of first fixed protruding portions 51p in a comb-teeth shape.

The plurality of first movable protruding portions 21p include a first movable end protruding portion 21a, a first movable other end protruding portion 21b, and a plurality of first movable intermediate protruding portions 21c. The first movable end protruding portion 21a is one end in the second direction D2 among the plurality of first movable protruding portions 21p. The first movable other end protruding portion 21b is another end in the second direction D2 among the plurality of first movable protruding portions 21p. The plurality of first movable intermediate protruding portions 21c are provided between the first movable end protruding portion 21a and the first movable other end protruding portion 21b.

A width of the first movable end protruding portion 21a along the second direction D2 is defined as a first movable end protruding portion width w21a. A width of the first movable other end protruding portion 21b along the second direction D2 is defined as a first movable other end protruding portion width w21b. In the embodiment, the first movable end protruding portion width w21a is substantially the same as the first movable other end protruding portion width w21b.

In the embodiment, as shown in FIG. 2, the element section 10U may further include a first opposing fixed electrode 51A. The first opposing fixed electrode 51A is fixed to the base 50S. At least a part of the first movable electrode 21 is provided between the first fixed electrode 51 and the first opposing fixed electrode 51A in the third direction D3. In one example, a first AC signal (drive signal) is applied between the first movable electrode 21 and the first opposing fixed electrode 51A. Thereby, the first movable structure 11M vibrates. By the vibration, the first intermediate beam portion 11c of the first beam 11 vibrates. The vibration includes a component in the third direction D3.

The plurality of first movable protruding portions 21p and the plurality of first fixed protruding portions 51p form a comb-teeth electrode pair. A signal (detection signal) generated between the first movable electrode 21 and the first fixed electrode 51 is detected. In this case, the first movable electrode 21 and the first fixed electrode 51 function as detection electrodes. For example, a change in resonance frequency is detected by tracking the phase of vibration (synchronous detection) based on a change in capacitance of a pair of comb-teeth electrodes. In the detection electrode, the widths of the two protruding portions located at the ends in the second direction D2 are set to be the same. Highly accurate detection can be performed stably.

For example, force is applied to the sensor 110 (for example, the first movable portion 10). As a result, the first other movable base portion 10B is displaced. The displacement includes a component in the third direction D3. Stress is applied to the first beam 11 due to the displacement of the first other movable base portion 10B. The stress can be compressive stress or tensile stress. The resonance frequency of the first beam 11 changes depending on the stress applied to the first beam 11. By detecting a change in the resonance frequency, a force (for example, acceleration) applied to the sensor 110 can be detected.

In the embodiment, the first movable end protruding portion width w21a is substantially the same as the first movable other end protruding portion width w21b. Thereby, deterioration in detection accuracy is suppressed. According to the embodiment, it is possible to provide a sensor that can obtain stable characteristics.

As shown in FIG. 1A, it is preferable that the first movable electrode 21 is line symmetrical with respect to a first line Ln1. The first line Ln1 passes through the first intermediate beam portion 11c and extends in the third direction D3. Higher accuracy can be stably obtained. The first fixed electrode 51 may be line symmetrical with respect to the first line Ln1.

For example, it is desirable that the first intermediate beam portion 11c is preferably at a center of the first beam 11 in the second direction D2. Detection with higher accuracy is possible.

As shown in FIG. 1A, the plurality of first fixed protruding portions 51p are provided between the first movable end protruding portion 21a and the first movable other end protruding portion 21b. A width of each of the plurality of first movable intermediate protruding portions 21c along the second direction D2 is defined as a first movable intermediate protruding portion width w21c. The first movable end protruding portion width w21a is larger than the first movable intermediate protruding portion width w21c. The first movable other end protruding portion width w21b is larger than the first movable intermediate protruding portion width w21c.

The plurality of first movable intermediate protruding portions 21c are not end protruding portions. Each of the plurality of first movable intermediate protruding portions 21c is sandwiched between one of the plurality of first fixed protruding portions 51p and another one of the plurality of first fixed protruding portions 51p. On the other hand, the first movable end protruding portion 21a and the first movable other end protruding portion 21b located at the ends are not sandwiched between the plurality of first fixed protruding portions 51p. The width of the protruding portions located at such an end is set larger than the width of the other protruding portions. Thereby, unintended deformation caused by asymmetric electrostatic attraction on the side faces of the comb teeth can be suppressed. It becomes easier to obtain more stable characteristics.

The first movable end protruding portion width w21a may be 1.2 times or more the first movable intermediate protruding portion width w21c. The first movable other end protruding portion width w21b may be 1.2 times or more the first movable intermediate protruding portion width w21c.

Practically, the first movable end protruding portion width w21a may be the width along the second direction D2 of the first movable end protruding portion 21a at the center of the first movable end protruding portion 21a in the third direction D3. Practically, the first movable other end protruding portion width w21b may be the width of the first movable other end protruding portion 21b along the second direction D2 at the center of the first movable other end protruding portion 21b in the third direction D3. Practically, the first movable intermediate protruding portion width w21c may be a width along the second direction D2 of one of the plurality of first movable intermediate protruding portions 21c at the center in the third direction D3 of one of the plurality of first movable intermediate protruding portions 21c. As will be described later, these widths may change along the third direction D3. In such a case, practically, the above definition for the width may be applied.

The above drive signal is supplied, for example, from the controller 70 (see FIG. 2). The above detection signal is detected by the controller 70. For example, the controller 70 is configured to detect a signal generated between the first movable electrode 21 and the first fixed electrode 51. Electrical connection between the controller 70 and the first movable electrode 21 may be performed, for example, via an electrode 10FE provided on the first fixed portion 10F.

As shown in FIG. 2, the element section 10U may further include a second fixed electrode 52. The second fixed electrode 52 is fixed to the base 50S. The first movable portion 10 may further include a second movable structure 12M. The second movable structure 12M includes a second beam 12, a second movable electrode 22, and a second connecting portion 12C.

The second beam 12 includes a second beam portion 12a, a second other beam portion 12b, and a second intermediate beam portion 12c. The second intermediate beam portion 12c is provided between the second beam portion 12a and the second other beam portion 12b. A direction from the second beam portion 12a to the second other beam portion 12b is along the second direction D2.

The second beam portion 12a is connected to the first movable base portion 10A. The second other beam portion 12b is connected to the first other movable base portion 10B. The second connecting portion 12C connects the second movable electrode 22 to the second intermediate beam portion 12c.

In this example, the second beam 12 is provided between the second movable electrode 22 and the first movable electrode 21. The first beam 11 is provided between the second beam 12 and the first movable electrode 21. The first movable connecting portion 10P is provided between the second beam 12 and the first beam 11 in the third direction D3. The second movable electrode 22 is provided between the second fixed electrode 52 and the second beam 12.

As shown in FIG. 1B, the second movable electrode 22 includes a second movable electrode base portion 22x and a plurality of second movable protruding portions 22p connected to the second movable electrode base portion 22x and arranged along the second direction D2. The second fixed electrode 52 includes a second fixed electrode base portion 52x and a plurality of second fixed protruding portions 52p connected to the second fixed electrode base portion 52x and arranged along the second direction D2. The plurality of second movable protruding portions 22p mesh with the plurality of second fixed protruding portions 52p in a comb-teeth shape.

The element section 10U may further include a second opposing fixed electrode 52A. The second opposing fixed electrode 52A is fixed to the base 50S. At least a part of the second movable electrode 22 is provided between the second fixed electrode 52 and the second opposing fixed electrode 52A in the third direction D3.

In the embodiment, a signal (detection signal) generated between the second movable electrode 22 and the second fixed electrode 52 may be detected. In this case, the second movable electrode 22 and the second fixed electrode 52 function as detection electrodes. On the other hand, an AC signal (drive signal) may be applied between the second movable electrode 22 and the second opposing fixed electrode 52A, so that the second beam 12 may vibrate. In this case, the second movable electrode 22 and the second opposing fixed electrode 52A function as driving electrodes.

For example, force is applied to the sensor 110 (for example, the first movable portion 10). As a result, the first other movable base portion 10B is displaced. Stress is applied to the second beam 12 due to the displacement of the first other movable base portion 10B. The stress can be compressive stress or tensile stress. Either compressive stress or tensile stress is applied to the first beam 11. In this case, the other of the compressive stress and the tensile stress is applied to the second beam 12.

For example, detection with higher accuracy is possible by detecting a difference between a first signal obtained from the first movable electrode 21 and the first fixed electrode 51 and a second signal obtained from the second movable electrode 22 and the second fixed electrode 52.

As shown in FIG. 1B, the plurality of second movable protruding portions 22p include a second movable end protruding portion 22a, a second movable other end protruding portion 22b, and a plurality of second movable intermediate protruding portions 22c. The second movable end protruding portion 22a is one end in the second direction D2 among the plurality of second movable protruding portions 22p. The second movable other end protruding portion 22b is another end in the second direction D2 among the plurality of second movable protruding portions 22p. The plurality of second movable intermediate protruding portions 22c are provided between the second movable end protruding portion 22a and the second movable other end protruding portion 22b.

A width of the first movable end protruding portion 21a along the second direction D2 is defined as a first movable end protruding portion width w21a. A width of the first movable other end protruding portion 21b along the second direction D2 is defined as a first movable other end protruding portion width w21b. In the embodiment, the first movable end protruding portion width w21a is substantially the same as the first movable other end protruding portion width w21b. Detection with higher accuracy is possible.

As shown in FIG. 1B, it is desirable that the second movable electrode 22 is line symmetrical with respect to a second line Ln2. The second line Ln2 passes through the second intermediate beam portion 12c and extends in the third direction D3. Higher accuracy can be stably obtained. The second fixed electrode 52 may be line symmetrical with respect to the second line Ln2.

For example, it is preferable that the second intermediate beam portion 12c is at a center of the second beam 12 in the second direction D2. Detection with higher accuracy is possible. As shown in FIG. 1B, the plurality of second fixed protruding portions 52p are provided between the second movable end protruding portion 22a and the second movable other end protruding portion 22b. A width of each of the plurality of second movable intermediate protruding portions 22c along the second direction D2 is defined as a second movable intermediate protruding portion width w22c. The second movable end protruding portion width w22a is larger than the second movable intermediate protruding portion width w22c. The second movable other end protruding portion width w22b is larger than the second movable intermediate protruding portion width w22c. For example, it is possible to suppress unintended deformation caused by asymmetric electrostatic attraction on the comb tooth side face of the end protruding portion. It becomes easier to obtain more stable characteristics.

The second movable end protruding portion width w22a may be 1.2 times or more the second movable intermediate protruding portion width w22c. The second movable other end protruding portion width w22b may be 1.2 times or more the second movable intermediate protruding portion width w22c.

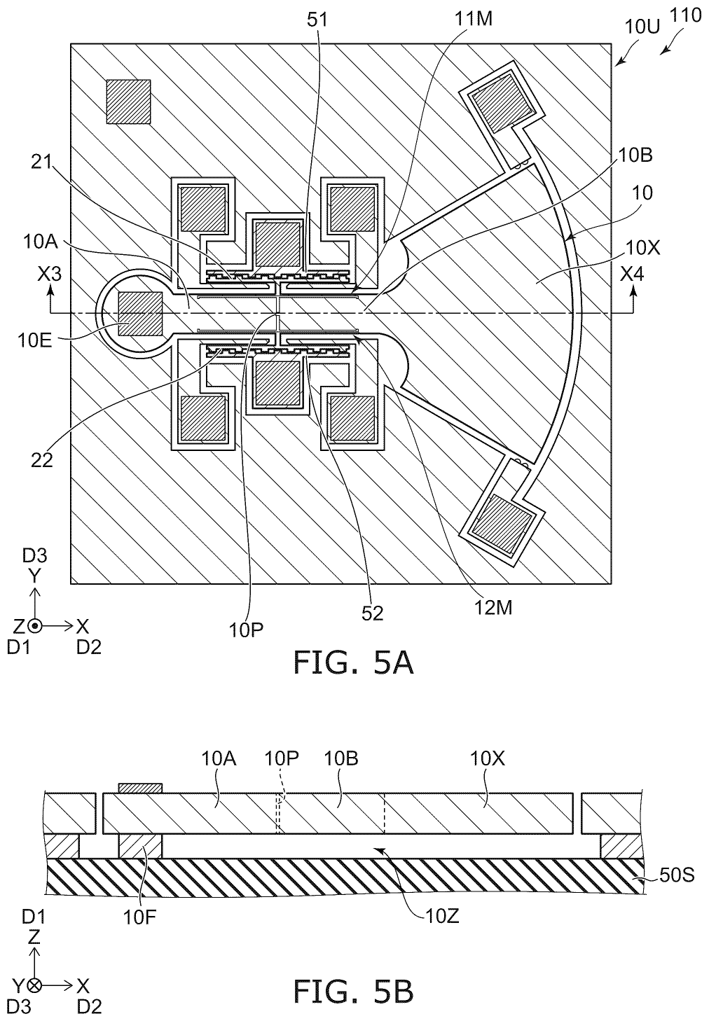

FIGS. 5A and 5B are schematic views illustrating the sensor according to the first embodiment.

FIG. 5A is a plan view. FIG. 5B corresponds to the cross-sectional view taken along the line X3-X4 in FIG. 5A.

As shown in FIG. 5A, the first movable portion 10 may include a first movable member 10X. The first other movable base portion 10B is provided between the first movable base portion 10A and the first movable member 10X in the second direction D2. The first movable member 10X functions, for example, as a proof mass. A width of the first movable member 10X in the third direction D3 is larger than the width of the first other movable base portion 10B in the third direction D3. The force applied from the outside is efficiently transmitted to the first beam 11 and the second beam 12 by the first movable member 10x. For example, high sensitivity can be obtained.

As shown in FIG. 1A, a distance along the third direction D3 between one of the plurality of first movable protruding portions 21p and the first fixed electrode base portion 51x is defined as a first distance d1. A distance along the second direction D2 between one of the plurality of first movable protruding portions 21p and one of the plurality of first fixed protruding portions 51p is defined as a second distance d2. The one of the plurality of first fixed protruding portions 51p is closest to one of the plurality of first movable protruding portions 21p among the plurality of first fixed protruding portions 51p. For example, no other first fixed protruding portions 51p are provided between the one of the first movable protruding portions 21p and the one of the first fixed protruding portions 51p.

For example, a first capacitance is formed between the tips of each of the plurality of first movable protruding portions 21p and the first fixed electrode base portion 51x. For example, a second capacitance is formed between the side faces of the plurality of first movable protruding portions 21p and the side faces of the plurality of first fixed protruding portions 51p. An electrostatic spring is formed depending on the change rate of these capacitances.

It is preferable that the change in the electrostatic spring constant is small when the first movable electrode 21 is displaced along the third direction D3. Thereby, detection with higher accuracy becomes easy. For example, when the first movable electrode 21 is displaced along the third direction D3, the change in the first capacitance is small. There is almost no change in the second capacitance when the first movable electrode 21 is displaced along the third direction D3.

For example, if the first distance d1 is too short, the change in the first capacitance with respect to the change in the first distance d1 becomes excessively large. By making the first distance d1 longer than a certain level, the change in the first capacitance with respect to the change in the first distance d1 can be kept small. For example, it is preferable that the first distance d1 is 0.79 times or more the second distance d2. Thereby, it becomes possible to reduce the influence of changes in capacitance. For example, higher accurate detection becomes easier.

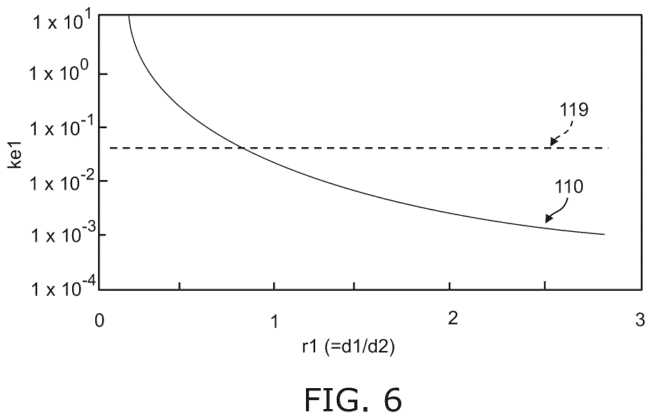

FIG. 6 is a graph illustrating the characteristics of the sensor according to the first embodiment.

The horizontal axis in FIG. 6 is a first ratio r1. The first ratio r1 is the ratio (d1/d2) of the first distance d1 to the second distance d2. The vertical axis is the electrostatic spring constant ke1 (μN/μm). FIG. 6 illustrates the characteristics of the sensor 110 and the characteristics of the sensor 119 as a reference example. As already explained, the sensor 110 is provided with a pair of comb-teeth electrodes. In the sensor 119, a pair of parallel plate electrodes is provided.

As shown in FIG. 6, in the sensor 110, as the first ratio r1 increases, the electrostatic spring constant ke1 decreases. When the first ratio r1 is 0.79 or more, the electrostatic spring constant ke1 in the sensor 110 becomes less than or equal to the electrostatic spring constant ke1 in the sensor 119. For example, when the first ratio r1 is 0.79 or more, an electrostatic spring constant ke1 less than the value in the parallel plate electrode pair can be obtained. Thereby, it becomes possible to reduce the influence of changes in the electrostatic spring constant. It is possible to suppress changes in characteristics due to changes in the electrostatic spring constant caused by warping of the base 50S due to thermal stress or the like and changes in the first distance d1. For example, the influence of characteristic fluctuations due to creep can be reduced. It becomes easier to stably obtain higher precision.

As shown in FIG. 1B, a distance along the third direction D3 between one of the plurality of second movable protruding portions 22p and the second fixed electrode base portion 52x is defined as a third distance d3. A distance along the second direction D2 between one of the plurality of second movable protruding portions 22p and one of the plurality of second fixed protruding portions 52p is defined as a fourth distance d4. The one of the plurality of second fixed protruding portions 52p is closest to one of the plurality of second movable protruding portions 22p among the plurality of second fixed protruding portions 52p. For example, no other second fixed protruding portions 52p are provided between the one of the second movable protruding portions 22p and the one of the second fixed protruding portions 52p.

For example, it is preferable that the third distance d3 is 0.79 times or more the fourth distance d4. For example, the influence of electrostatic springs can be reduced. For example, changes in characteristics caused by changes in the electrostatic spring constant caused by warping of the base 50S due to thermal stress or the like and changes in the third distance d3 can be suppressed. For example, the influence of characteristic fluctuations due to creep can be reduced. It becomes easier to stably obtain higher accuracy.

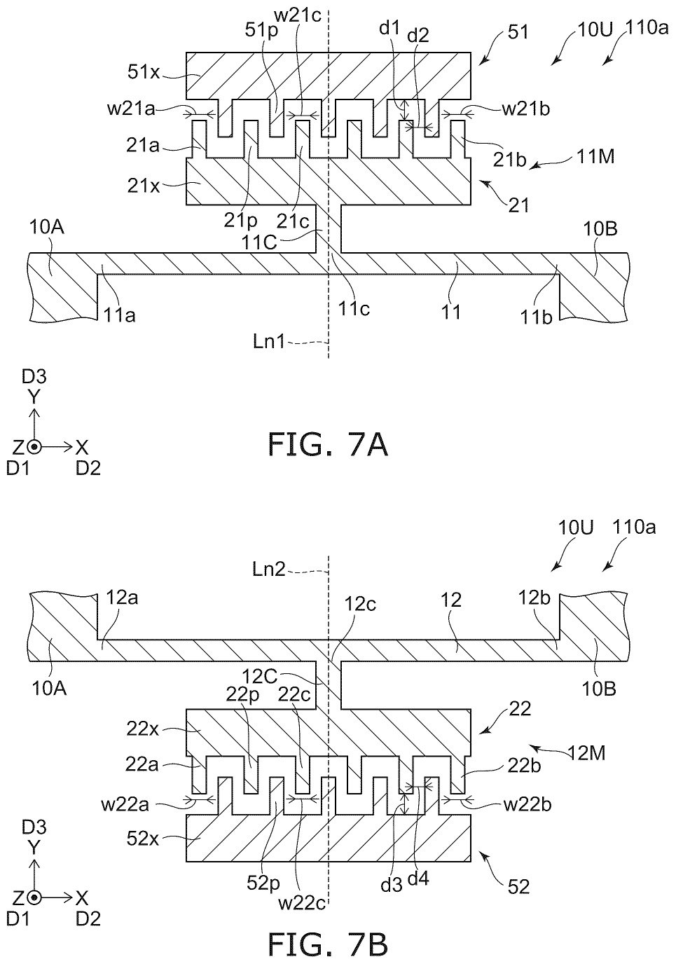

FIGS. 7A and 7B are schematic plan views illustrating a part of a sensor according to the first embodiment.

FIG. 7A illustrates the first movable electrode 21 in a sensor 110a according to the embodiment. FIG. 7B illustrates the second movable electrode 22 in the sensor 110a. The configuration of the sensor 110a may be the same as the configuration of the sensor 110, except for the configuration of these movable electrodes.

In the sensor 110a, the first movable end protruding portion width w21a and the first movable other end protruding portion width w21b are substantially the same as the first movable intermediate protruding portion width w21c. In this case as well, for example, the first movable electrode 21 is line symmetrical with respect to the first line Ln1. By the high symmetry, high detection accuracy can be obtained in the sensor 110a. Stable characteristics can be obtained.

In the sensor 110a, the second movable end protruding portion width w22a and the second movable other end protruding portion width w22b are substantially the same as the second movable intermediate protruding portion width w22c. In this case as well, for example, the second movable electrode 22 is line symmetrical with respect to the second line Ln2. By the high symmetry, high detection accuracy can be obtained in the sensor 110a. Stable characteristics can be obtained.

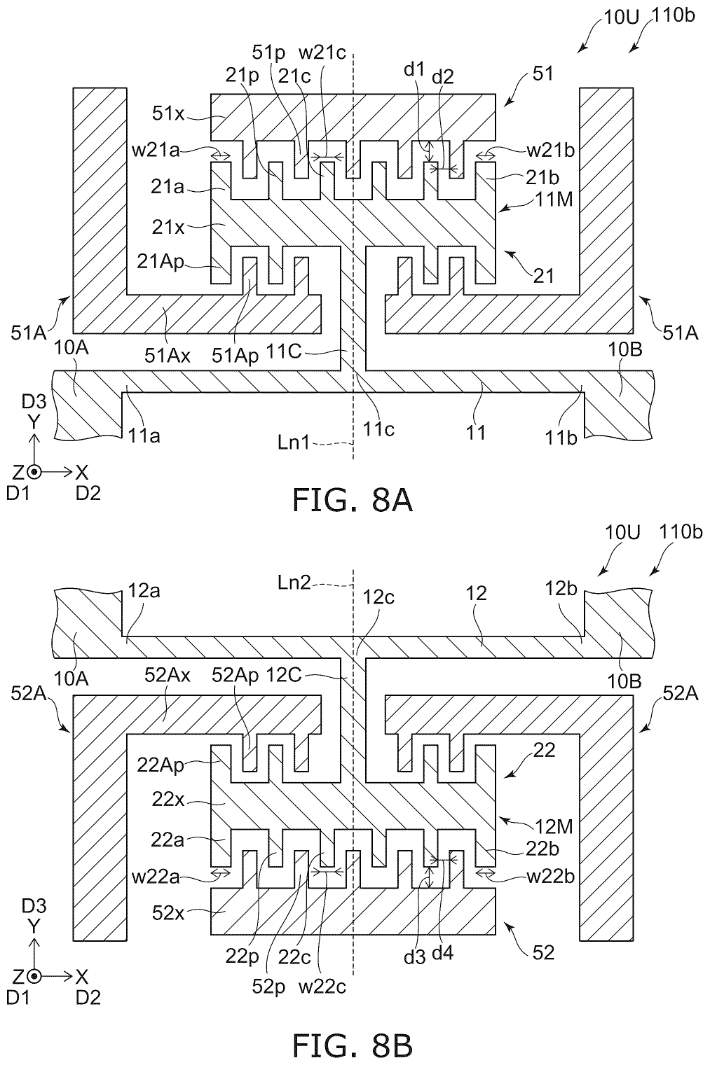

FIGS. 8A and 8B are schematic plan views illustrating a part of a sensor according to the first embodiment.

These figures illustrate the configuration of the element section 10U in a sensor 110b according to the embodiment. As shown in FIG. 8A, in the sensor 110b, the element section 10U further includes the first opposing fixed electrode 51A. As shown in FIG. 8B, in the sensor 110b, the element section 10U further includes the second opposing fixed electrode 52A. The configuration of the sensor 110b may be the same as the configuration of the sensor 110, except for these opposing fixed electrodes.

The first opposing fixed electrode 51A is fixed to the base 50S. At least a part of the first movable electrode 21 is provided between the first opposing fixed electrode 51A and the first fixed electrode 51 in the third direction D3.

The first movable electrode 21 further includes a plurality of first opposing movable protruding portions 21Ap. The plurality of first opposing movable protruding portions 21Ap are connected to the first movable electrode base portion 21x and are arranged along the second direction D2. The first movable electrode base portion 21x is provided between the plurality of first opposing movable protruding portions 21Ap and the plurality of first movable protruding portions 21p.

The first opposing fixed electrode 51A includes a first opposing fixed electrode base portion 51Ax and a plurality of first opposing fixed protruding portions 51Ap. The plurality of first opposing fixed protruding portions 51Ap are connected to the first opposing fixed electrode base portion 51Ax and are arranged along the second direction D2. The plurality of first opposing movable protruding portions 21Ap mesh with the plurality of first opposing fixed protruding portions 51Ap in a comb-teeth shape.

An AC signal may be applied between the first movable electrode 21 and the first opposing fixed electrode 51A. A signal between the first movable electrode 21 and the first opposing fixed electrode 51A may be detected.

In the embodiment, an AC signal may be applied between the first movable electrode 21 and the first fixed electrode 51. A signal between the first movable electrode 21 and the first fixed electrode 51 may be detected.

The second opposing fixed electrode 52A is fixed to the base 50S. At least a part of the second movable electrode 22 is provided between the second opposing fixed electrode 52A and the second fixed electrode 52 in the third direction D3.

The second movable electrode 22 further includes a plurality of second opposing movable protruding portions 22Ap.

The plurality of second opposing movable protruding portions 22Ap are connected to the second movable electrode base portion 22x and are arranged along the second direction D2. The second movable electrode base portion 22x is provided between the plurality of second opposing movable protruding portions 22Ap and the plurality of second movable protruding portions 22p. The second opposing fixed electrode 52A includes a second opposing fixed electrode base portion 52Ax and a plurality of second opposing fixed protruding portions 52Ap. The plurality of second opposing fixed protruding portions 52Ap are connected to the second opposing fixed electrode base portion 52Ax and are arranged along the second direction D2. The plurality of second opposing movable protruding portions 22Ap mesh with the plurality of second opposing fixed protruding portions 52Ap in a comb-teeth shape.

An AC signal may be applied between the second movable electrode 22 and the second opposing fixed electrode 52A. A signal between the second movable electrode 22 and the second opposing fixed electrode 52A may be detected.

In the embodiment, an AC signal may be applied between the second movable electrode 22 and the second fixed electrode 52. A signal between the second movable electrode 22 and the second fixed electrode 52 may be detected.

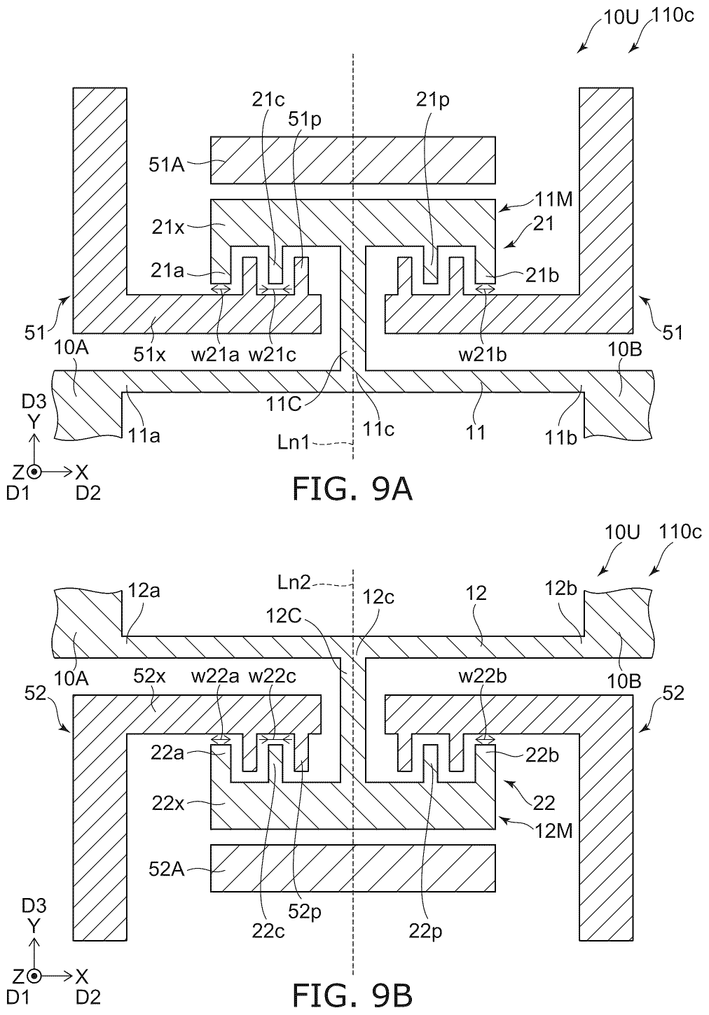

FIGS. 9A and 9B are schematic plan views illustrating a part of a sensor according to the first embodiment.

These figures illustrate the configuration of the element section 10U in a sensor 110c according to the embodiment. As shown in FIG. 9A, in the sensor 110c, at least a part of the first fixed electrode 51 is provided between at least a part of the first movable electrode 21 and the first beam 11. As shown in FIG. 9B, in the sensor 110c, at least a part of the second fixed electrode 52 is provided between at least a part of the second movable electrode 22 and the second beam 12. In the sensor 110c, the first opposing fixed electrode 51A and the first movable electrode 21 form a parallel plate electrode pair. In the sensor 110c, the second opposing fixed electrode 52A and the second movable electrode 22 form a parallel plate electrode pair. Except for these points, the configuration of the sensor 110c may be the same as the configuration of the sensor 110. Stable characteristics can also be obtained in the sensor 110c.

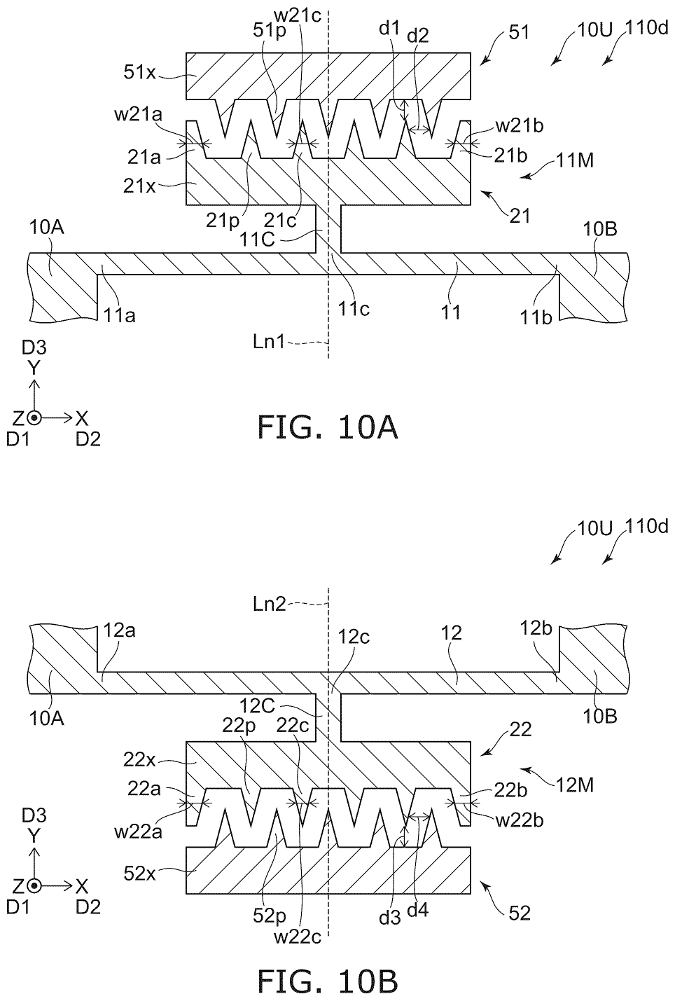

FIGS. 10A and 10B are schematic plan views illustrating a part of a sensor according to the first embodiment.

These figures illustrate the configuration of the element section 10U in a sensor 110d according to the embodiment. In the sensor 110d, the width of the protruding portions changes. Except for this, the configuration of the sensor 110d may be the same as the configuration of the sensor 110.

In the sensor 110d, the first movable intermediate protruding portion width w21c decreases as the distance from the first movable electrode base portion 21x increases. The width of one of the plurality of first fixed protruding portions 51p along the second direction D2 decreases as the distance from the first fixed electrode base portion 51x increases.

In the sensor 110d, the second movable intermediate protruding portion width w22c decreases as the distance from the second movable electrode base portion 22x increases. The width of one of the plurality of second fixed protruding portions 52p along the second direction D2 decreases as the distance from the second fixed electrode base portion 52x increases.

In in the sensor 110d as well, the first movable end protruding portion width w21a is substantially the same as the first movable other end protruding portion width w21b. For example, the first movable electrode 21 may be line symmetrical with respect to the first line Ln1. For example, the first movable end protruding portion width w21a may be larger than the first movable intermediate protruding portion width w21c. The first movable other end protruding portion width w21b may be larger than the first movable intermediate protruding portion width w21c.

In the sensor 110d as well, the second movable end protruding portion width w22a is substantially the same as the second movable other end protruding portion width w22b. For example, the second movable electrode 22 may be line symmetrical with respect to the second line Ln2. For example, the second movable end protruding portion width w22a may be larger than the second movable intermediate protruding portion width w22c. The second movable other end protruding portion width w22b may be larger than the second movable intermediate protruding portion width w22c.

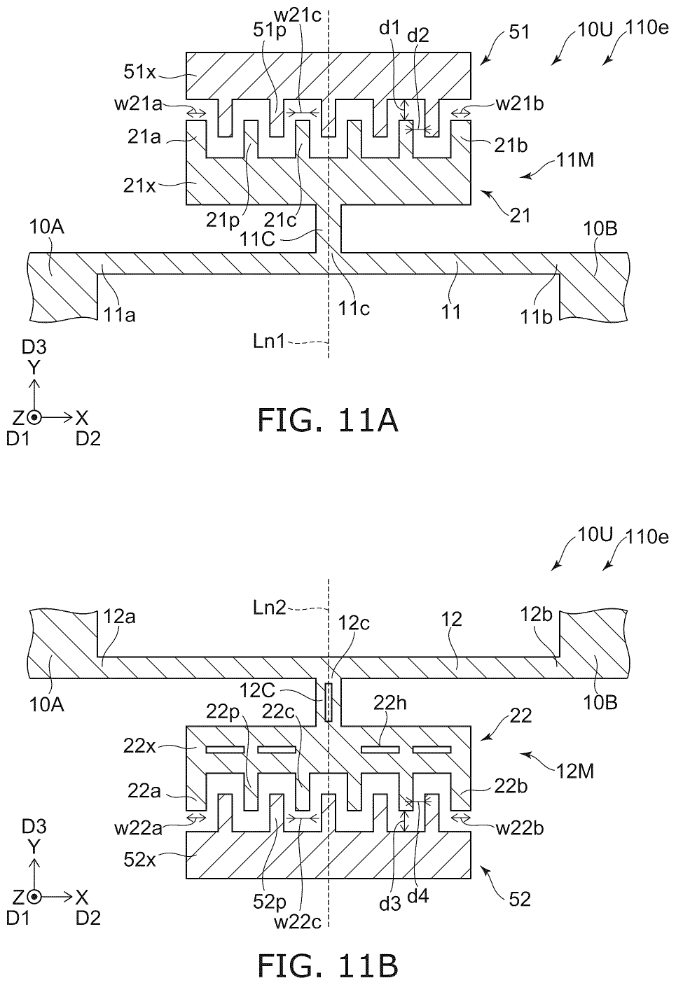

FIGS. 11A and 11B are schematic plan views illustrating a part of a sensor according to the first embodiment.

These figures illustrate the configuration of the element section 10U in a sensor 110e according to the embodiment. In the sensor 110e, the configuration of the second movable electrode 22 is different from the configuration of the first movable electrode 21. Except for this, the configuration of the sensor 110e may be the same as the configuration of the sensor 110.

In the sensor 110e, the second movable electrode 22 includes a second hole 22h, and the first movable electrode 21 does not include a first hole. With such a configuration, the resonance frequency of the second movable structure 12M including the second movable electrode 22 is different from the resonance frequency of the first movable structure 11M including the first movable electrode 21. For example, a wide dynamic range can be obtained. For example, it is possible to detect a wide dynamic range with high accuracy. For example, the signal obtained from the first movable electrode 21 and the signal obtained from the second movable electrode 22 may be processed.

In the embodiment, the first movable electrode 21 and the second movable electrode 22 may satisfy at least one of a first condition, a second condition, a third condition, a fourth condition, a fifth condition, a sixth condition, a seventh condition, an eighth condition, and a nine condition.

In the first condition, a second mass of the second movable electrode 22 is different from a first mass of the first movable electrode 21. In the second condition, a second thickness of the second movable electrode 22 along the first direction D1 is different from a first thickness of the first movable electrode 21 along the first direction D1. In the third condition, at least a part of a second material included in the second movable electrode 22 is different from at least a part of a first material included in the first movable electrode 21.

In the fourth condition, the second movable electrode 22 includes the second hole 22h, and the first movable electrode 21 does not include the first hole. In the fifth condition, a second size of the second hole 22h included in the second movable electrode 22 is different from a first size of the first hole included in the first movable electrode 21. In the sixth condition, a second density of the second holes 22h is different from a first density of the first holes.

In the seventh condition, a second number of the second holes 22h is different from a first number of the first holes. In the eighth condition, a second shape of the second hole 22h is different from a first shape of the first hole. In the ninth condition, a second layer structure of the second movable electrode 22 is different from a first layer structure of the first movable electrode 21.

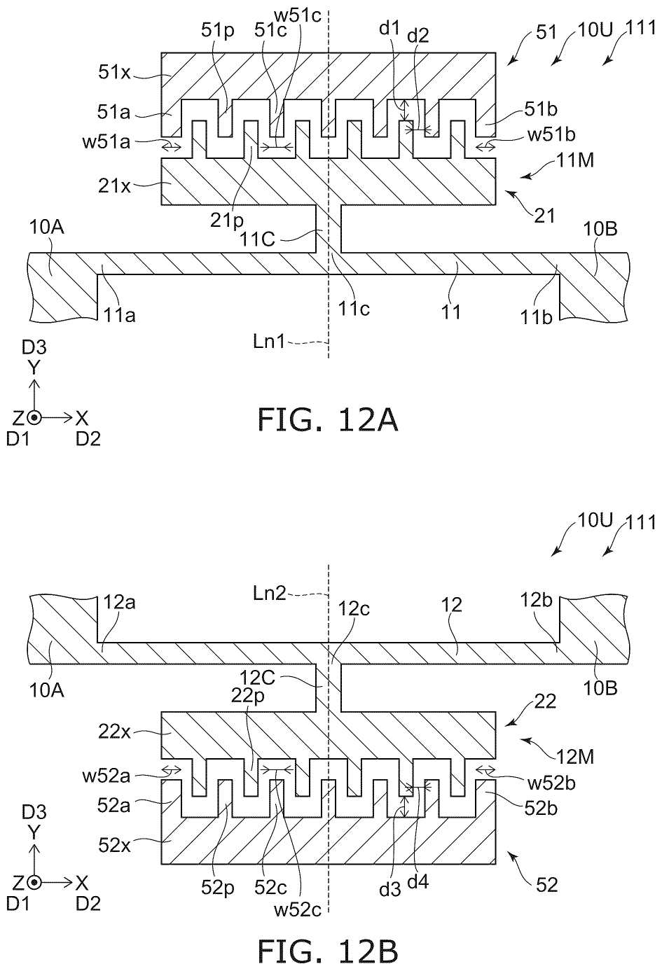

FIGS. 12A and 12B are schematic plan views illustrating a part of a sensor according to the first embodiment.

These figures illustrate the configuration of the element section 10U in a sensor 111 according to the embodiment. In the sensor 111, the configuration of the movable electrode and the fixed electrode is different from the configuration in the sensor 110. Except for this, the configuration of the sensor 111 may be the same as the configuration of the sensor 110.

In the sensor 111, the plurality of first fixed protruding portions 51p include a first fixed end protruding portion 51a, a first fixed other end protruding portion 51b, and a plurality of first fixed intermediate protruding portions 51c. The first fixed end protruding portion 51a is one end in the second direction D2 among the plurality of first fixed protruding portions 51p. The first fixed other end protruding portion 51b is another end in the second direction D2 among the plurality of first fixed protruding portions 51p. The plurality of first fixed intermediate protruding portions 51c are provided between the first fixed end protruding portion 51a and the first fixed other end protruding portion 51b.

In the embodiment, a first fixed end protruding portion width w51a of the first fixed end protruding portion 51a along the second direction D2 is substantially the same as a first fixed other end protruding portion width w51b of the first fixed other end protruding portion 51b along the second direction D2.

For example, the plurality of first movable protruding portions 21p are provided between the first fixed end protruding portion 51a and the first fixed other end protruding portion 51b. The first fixed end protruding portion width w51a is larger than the first fixed intermediate protruding portion width w51c along the second direction D2 of each of the plurality of first fixed intermediate protruding portions 51c. The first fixed other-end protruding portion width w51b is larger than the first fixed intermediate protruding portion width w51c.

For example, the first fixed electrode 51 may be line symmetrical with respect to the first line Ln1. The first line Ln1 passes through the first intermediate beam portion 11c and extends in the third direction D3. The first movable electrode 21 may be line symmetrical with respect to the first line Ln1. For example, unintended deformation of the protruding portions is suppressed. Deterioration of detection accuracy is suppressed. According to the embodiment, it is possible to provide a sensor that can obtain stable characteristics.

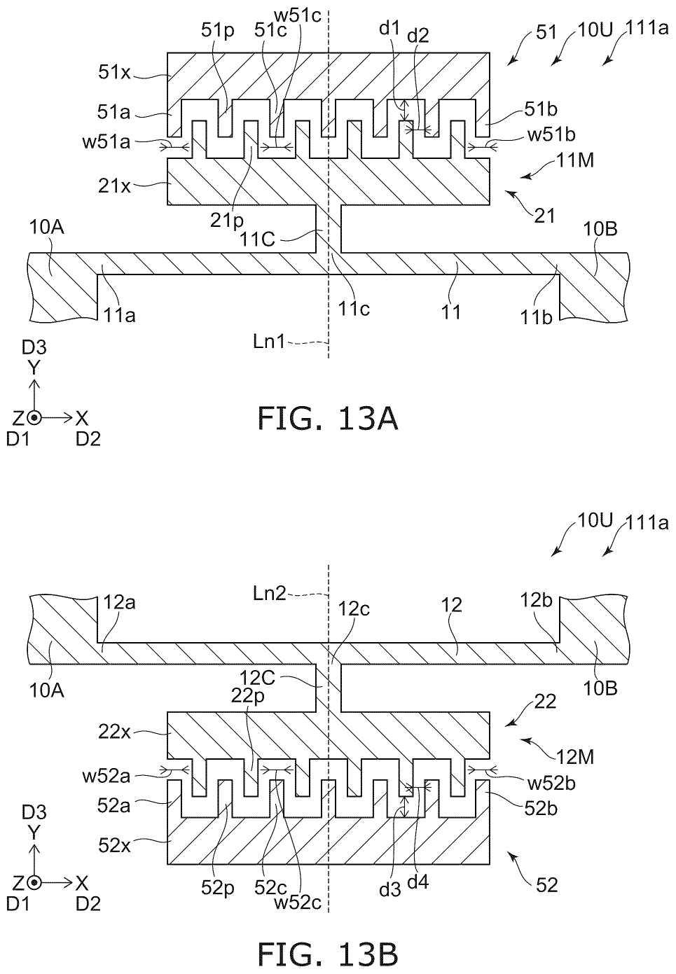

FIGS. 13A and 13B are schematic plan views illustrating a part of a sensor according to the first embodiment.

These figures illustrate the configuration of the element section 10U in a sensor 111a according to the embodiment. In the sensor 111a, the first fixed end protruding portion width w51a is substantially the same as the first fixed intermediate protruding portion width w51c. The first fixed other end protruding portion width w51b is substantially the same as the first fixed intermediate protruding portion width w51c. Except for this, the configuration of the sensor 111a may be the same as the configuration of the sensor 111. In the sensor 111a, for example, the first fixed electrode 51 is line symmetrical with respect to the first line Ln1. The first movable electrode 21 is line symmetrical with respect to the first line Ln1.

In the sensor 111a, the second fixed end protruding portion width w52a is substantially the same as the second fixed intermediate protruding portion width w52c. The second fixed other end protruding portion width w52b is substantially the same as the second fixed intermediate protruding portion width w52c. In the sensor 111a, for example, the second fixed electrode 52 may be line symmetrical with respect to the second line Ln2. The second movable electrode 22 may be line symmetrical with respect to the second line Ln2.

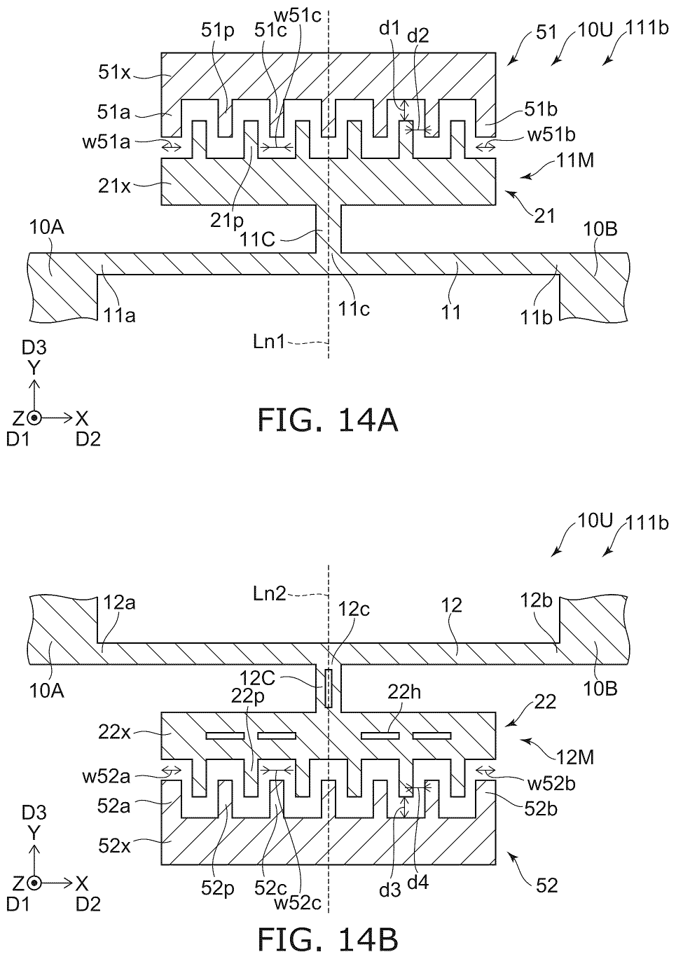

FIGS. 14A and 14B are schematic plan views illustrating a part of a sensor according to the first embodiment.

These figures illustrate the configuration of the element section 10U in a sensor 111b according to the embodiment. In the sensor 111b, the second movable electrode 22 includes a second hole 22h. Except for this, the configuration of the sensor 111b may be the same as the configuration of the sensor 111.

In the sensor 111b, the first movable electrode 21 and the second movable electrode 22 satisfy at least any one of the first to ninth conditions described above.

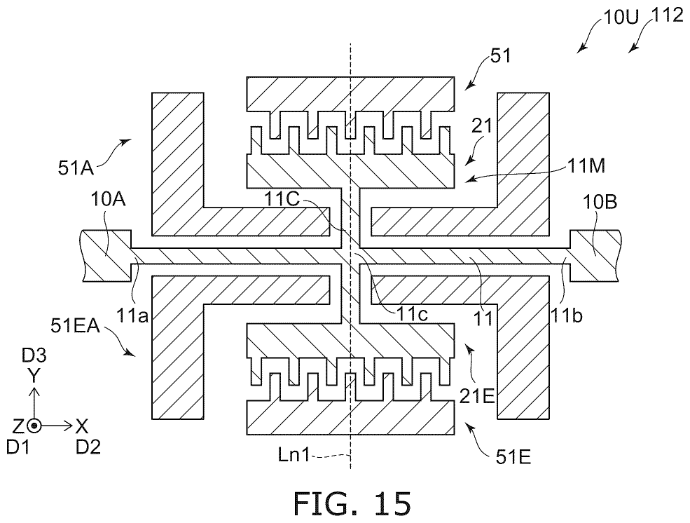

FIG. 15 is a schematic plan view illustrating a part of a sensor according to the first embodiment.

FIG. 15 illustrates the configuration of the element section 10U in a sensor 112 according to the embodiment. In the sensor 112, the first movable structure 11M includes a first other movable electrode 21E. The element section 10U includes a first other fixed electrode 51E. The configuration of the sensor 112 other than these may be the same as the configuration of the sensor 110 and the like.

The first other movable electrode 21E is connected to the first intermediate beam portion 11c. In the third direction D3, the first beam 11 is provided between the first other movable electrode 21E and the first movable electrode 21. The first other movable electrode 21E is line symmetrical with the first movable electrode 21 with the first beam 11 as the axis of symmetry. The first other movable electrode 21E faces the first other fixed electrode 51E.

The element section 10U may further include a first other opposing fixed electrode 51EA. The first other opposing fixed electrode 51EA is fixed to the base 50S. At least a part of the first other movable electrode 21E is provided between the first other fixed electrode 51E and the first other opposing fixed electrode 51EA in the third direction D3.

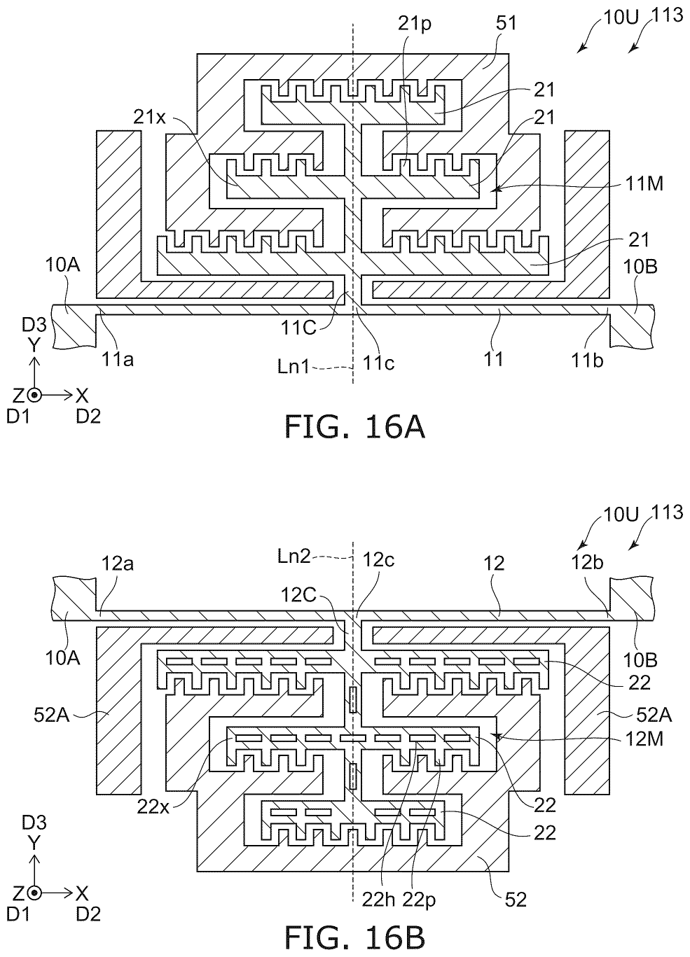

FIGS. 16A and 16B are schematic plan views illustrating a part of a sensor according to the first embodiment.

These figures illustrate the configuration of the element section 10U in a sensor 113 according to the embodiment. In the sensor 113, a plurality of first movable electrodes 21 are provided. Except for this, the configuration of the sensor 113 may be the same as the configuration of the sensor 110.

In the sensor 113, the first movable structure 11M includes the plurality of first movable electrodes 21. The first connecting portion 11C connects the plurality of first movable electrodes 21 to the first intermediate beam portion 11c. One of the plurality of first movable electrodes 21 is provided between another one of the plurality of first movable electrodes 21 and the first beam 11. A length of one of the plurality of first movable electrodes 21 along the second direction D2 is longer than a length of another one of the plurality of first movable electrodes 21 along the second direction D2.

In the sensor 113, the second movable structure 12M includes a plurality of second movable electrodes 22. The second connecting portion 12C connects the plurality of second movable electrodes 22 to the second intermediate beam portion 12c. One of the plurality of second movable electrodes 22 is provided between another one of the plurality of second movable electrodes 22 and the second beam 12. A length of one of the plurality of second movable electrodes 22 along the second direction D2 is longer than a length of another one of the plurality of second movable electrodes 22 along the second direction D2. In the sensor 113, for example, higher sensitivity can be easily obtained by using a plurality of movable electrodes.

Hereinafter, some examples of sensors according to embodiments will be described. The configuration of the sensor may be the same as the configuration of the sensor described above, except for the configuration described below.

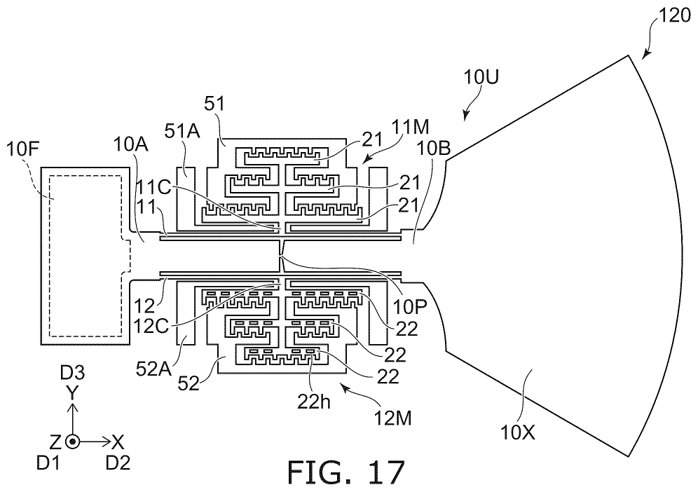

FIGS. 17 to 29 are schematic plan views illustrating the sensor according to the first embodiment.

As shown in FIG. 17, in a sensor 120, the first movable structure 11M includes the plurality of first movable electrodes 21. The second movable structure 12M includes the plurality of second movable electrodes 22. The first movable structure 11M is connected to the first beam 11. The second movable structure 12M is connected to the second beam 12.

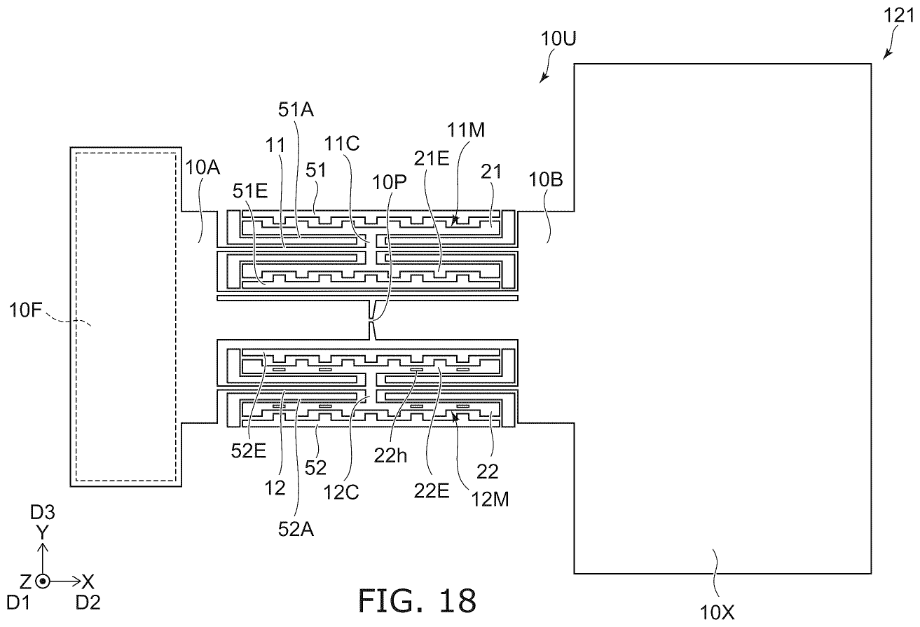

As shown in FIG. 18, in a sensor 121, the first movable structure 11M includes the first movable electrode 21 and the first other movable electrode 21E. The second movable structure 12M includes the second movable electrode 22 and the second other movable electrode 22E. The first movable electrode 21 faces the first fixed electrode 51. The first other movable electrode 21E faces the first other fixed electrode 51E. The second movable electrode 22 faces the second fixed electrode 52. The second other movable electrode 22E faces the second other fixed electrode 52E.

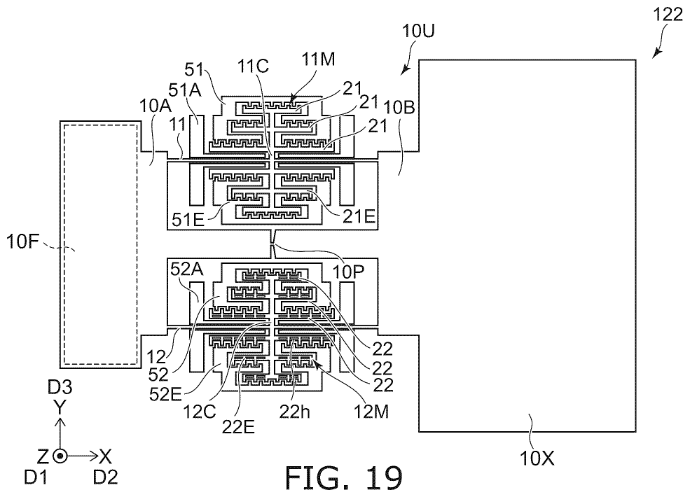

As shown in FIG. 19, in a sensor 122, the first movable structure 11M includes the plurality of first movable electrodes 21. The second movable structure 12M includes the plurality of second movable electrodes 22. The first movable structure 11M is connected to the first beam 11. The second movable structure 12M is connected to the second beam 12.

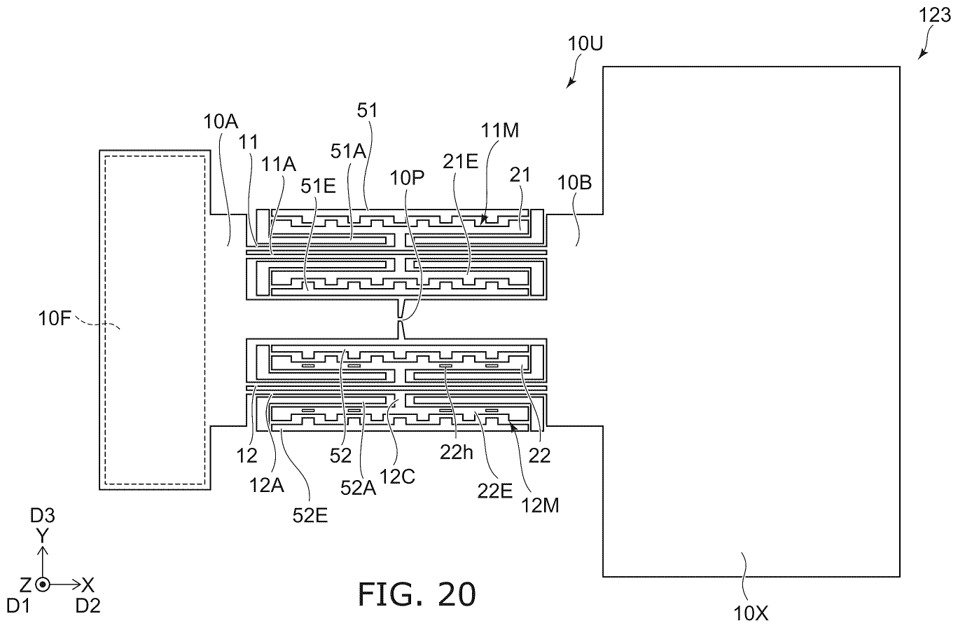

As shown in FIG. 20, in a sensor 123, the first movable structure 11M includes the first movable electrode 21 and the first other movable electrode 21E. The second movable structure 12M includes the second movable electrode 22 and the second other movable electrode 22E. The first movable portion 10 includes the first other beam 11A and the second other beam 12A. One end of the first other beam 11A is connected to the first movable base portion 10A. The other end of the first other beam 11A is connected to the first other movable base portion 10B. One end of the second other beam 12A is connected to the first movable base portion 10A. The other end of the second other beam 12A is connected to the first other movable base portion 10B. The first other beam 11A and the second other beam 12A extend along the second direction D2. The first other movable electrode 21E is connected to the first other beam 11A. The first other beam 11A is provided between the first other movable electrode 21E and the first beam 11 in the second direction D2. The second other movable electrode 22E is connected to the second other beam 12A. The second other beam 12A is provided between the second other movable electrode 22E and the second beam 12 in the second direction D2.

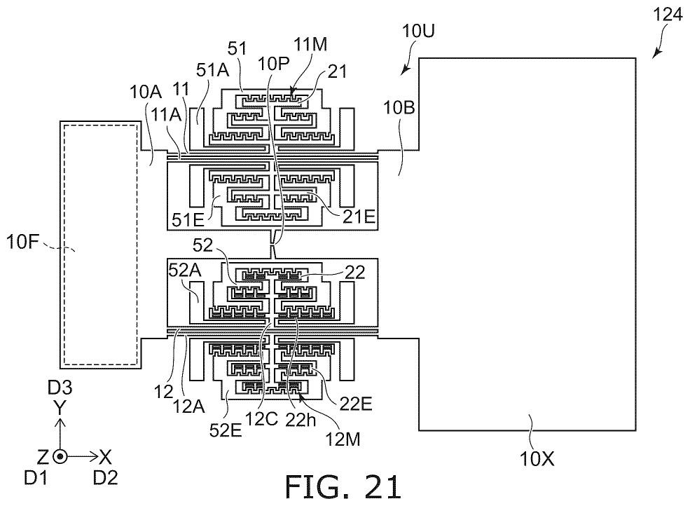

As shown in FIG. 21, in a sensor 124, the first movable portion 10 includes the first other beam 11A and the second other beam 12A. The first other movable electrode 21E is connected to the first other beam 11A. The second other movable electrode 22E is connected to the second other beam 12A. In the sensor 124, the plurality of first movable electrodes 21 and the plurality of first other movable electrodes 21E are provided. The plurality of second movable electrodes 22 and the plurality of second other movable electrodes 22E are provided.

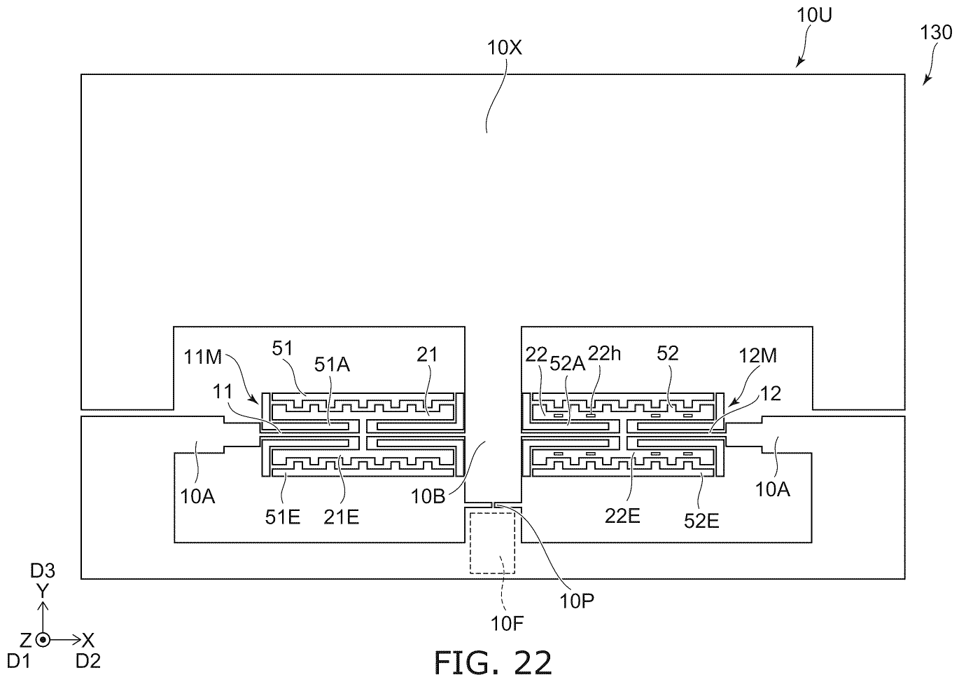

As shown in FIG. 22, in a sensor 130, the first movable base portion 10A includes a plurality of regions. One end of the first beam 11 is connected to one of the plurality of regions of the first movable base portion 10A. The other end of the first beam 11 is connected to the first other movable base portion 10B.

One end of the second beam 12 is connected to another one of the plurality of regions of the first movable base portion 10A. The other end of the second beam 12 is connected to the first other movable base portion 10B. The direction from the first beam 11 to the second beam 12 is along the second direction D2. The first movable electrode 21 and the first other movable electrode 21E included in the first movable structure 11M are connected to the first beam 11. The second movable electrode 22 and the second other movable electrode 22E included in the second movable structure 12M are connected to the second beam 12.

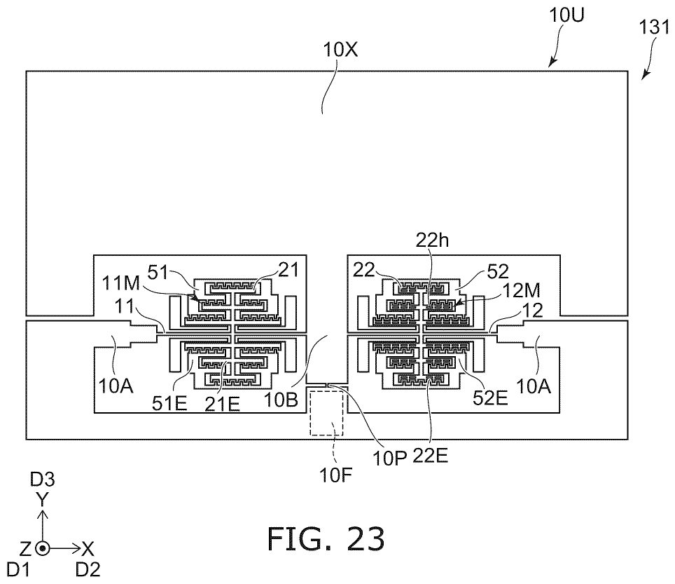

As shown in FIG. 23, in a sensor 131, the plurality of first movable electrodes 21 and the plurality of first other movable electrodes 21E are connected to the first beam 11. The plurality of second movable electrodes 22 and the plurality of second other movable electrodes 22E are connected to the second beam 12. The configuration of the sensor 131 except for this may be the same as the configuration of the sensor 130.

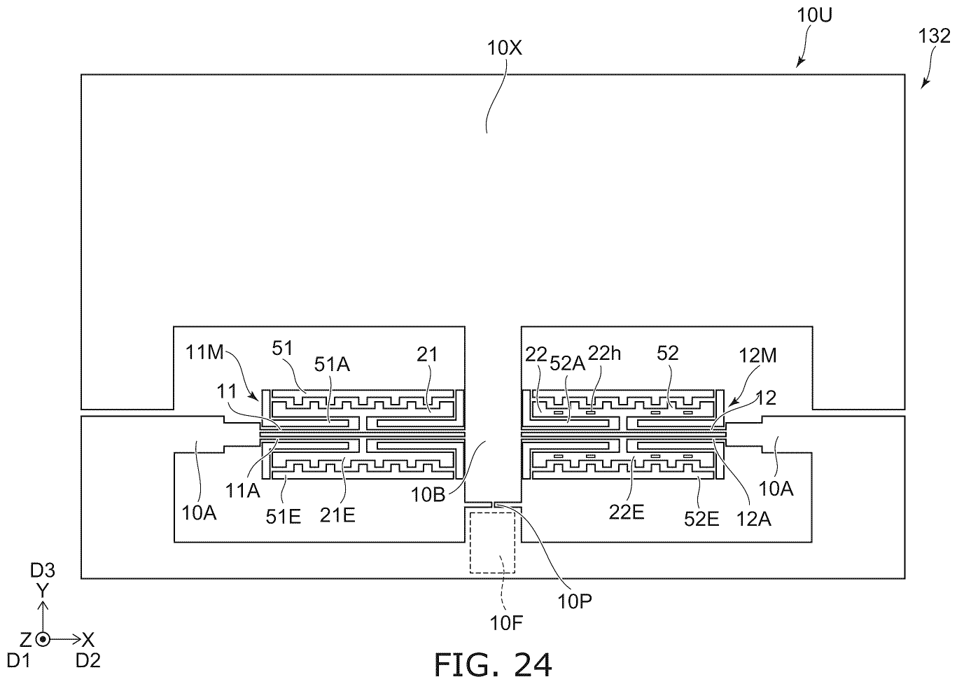

As shown in FIG. 24, in a sensor 132, the first movable electrode 21 is connected to the first beam 11. The first other movable electrode 21E is connected to the first other beam 11A. The second movable electrode 22 is connected to the second beam 12. The second other movable electrode 22E is connected to the second other beam 12A. The configuration of the sensor 132 except for this may be the same as the configuration of the sensor 130. The direction from the first other beam 11A to the second other beam 12A is along the second direction D2.

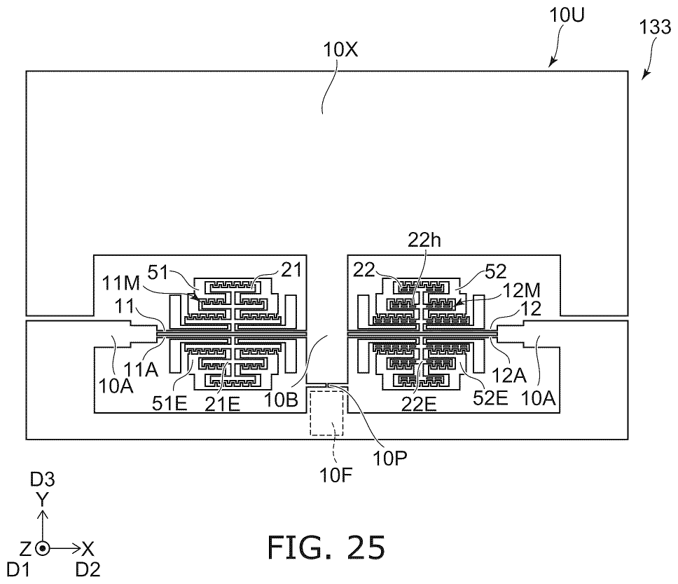

As shown in FIG. 25, in a sensor 133, the plurality of first movable electrodes 21 are connected to the first beam 11. The plurality of first other movable electrodes 21E are connected to the first other beam 11A. The plurality of second movable electrodes 22 are connected to the second beam 12. The second other movable electrode 22E is connected to the second other beam 12A. The configuration of the sensor 133 except for this may be the same as the configuration of the sensor 132.

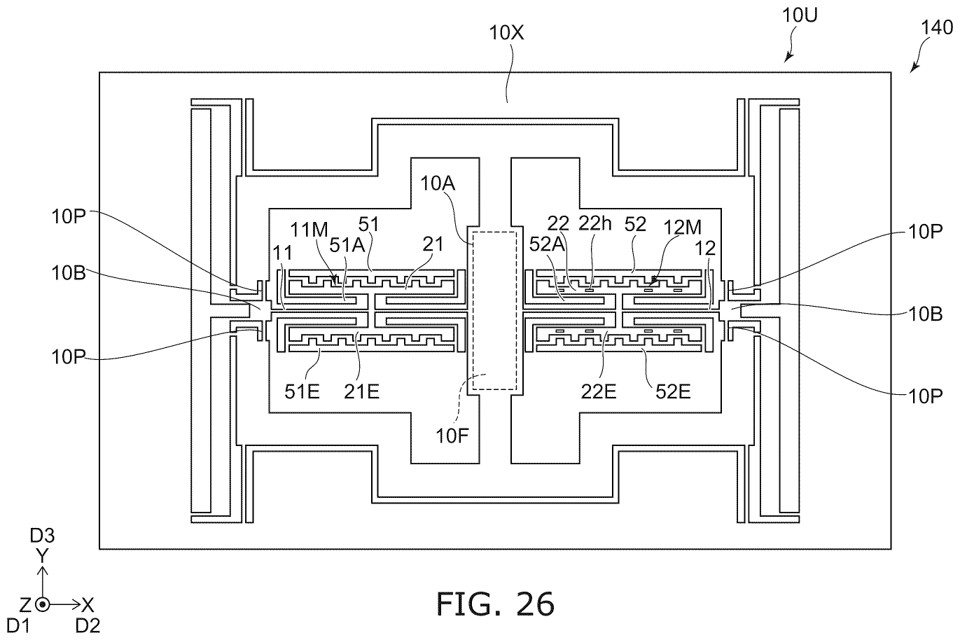

As illustrated in FIG. 26, in the sensor 140, the first other movable base portion 10B includes a plurality of regions. One of the plurality of regions included in the first other movable base portion 10B is connected to the first movable base portion 10A by the plurality of first movable connecting portions 10P. One of the plurality of regions included in the first other movable base portion 10B is provided between one of the plurality of first movable connecting portions 10P and another one of the plurality of first movable connecting portions 10P in the third direction D3. Another one of the plurality of regions included in the first other movable base portion 10B is connected to the first movable base portion 10A by the plurality of first movable connecting portions 10P. Another one of the plurality of regions included in the first other movable base portion 10B is provided between one of the plurality of first movable connecting portions 10P and another one of the plurality of first movable connecting portions 10P in the third direction D3.

In the sensor 140, the first movable electrode 21 and the first other movable electrode 21E are connected to the first beam 11. The second movable electrode 22 and the second other movable electrode 22E are connected to the second beam 12.

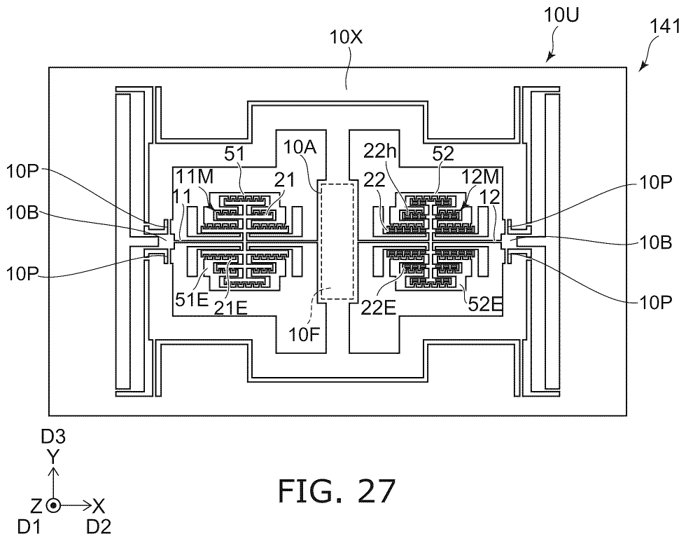

As illustrated in FIG. 27, the plurality of first movable electrodes 21 and the plurality of first other movable electrodes 21E are provided in the sensor 141. The plurality of second movable electrodes 22 and the plurality of second other movable electrodes 22E are provided. Except for these, the configuration of the sensor 133 may be the same as the configuration of the sensor 140.

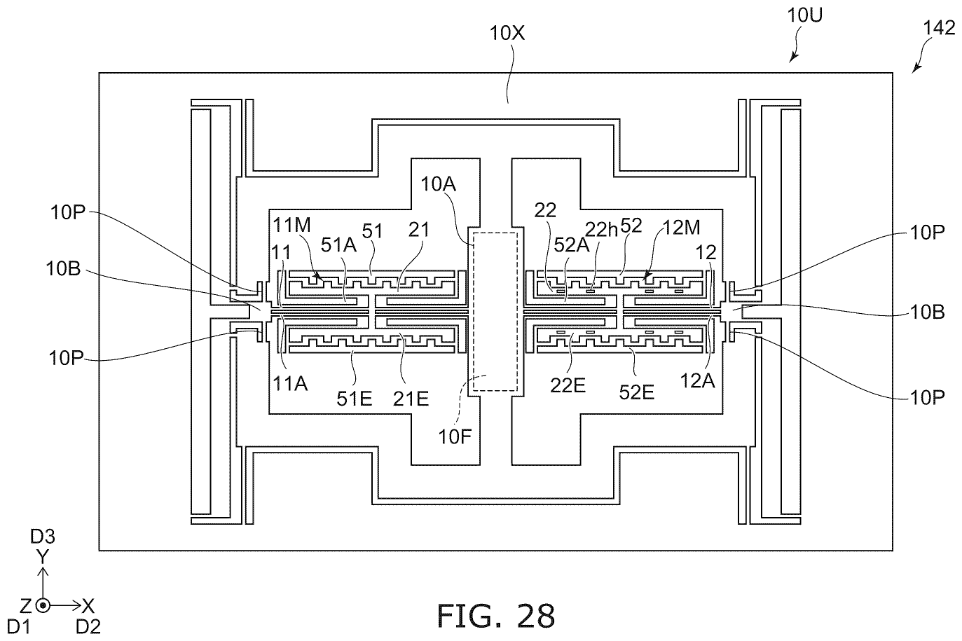

As shown in FIG. 28, in a sensor 142, the first other beam 11A and the second other beam 12A are provided. A direction from the first beam 11 to the second beam 12 is along the second direction D2. Ae direction from the first other beam 11A to the second other beam 12A is along the second direction D2. A direction from the first other beam 11A to the first beam 11 is along the third direction D3. A direction from the second other beam 12A to the second beam 12 is along the third direction D3. The configuration of the sensor 142 except for this may be the same as the configuration of the sensor 140.

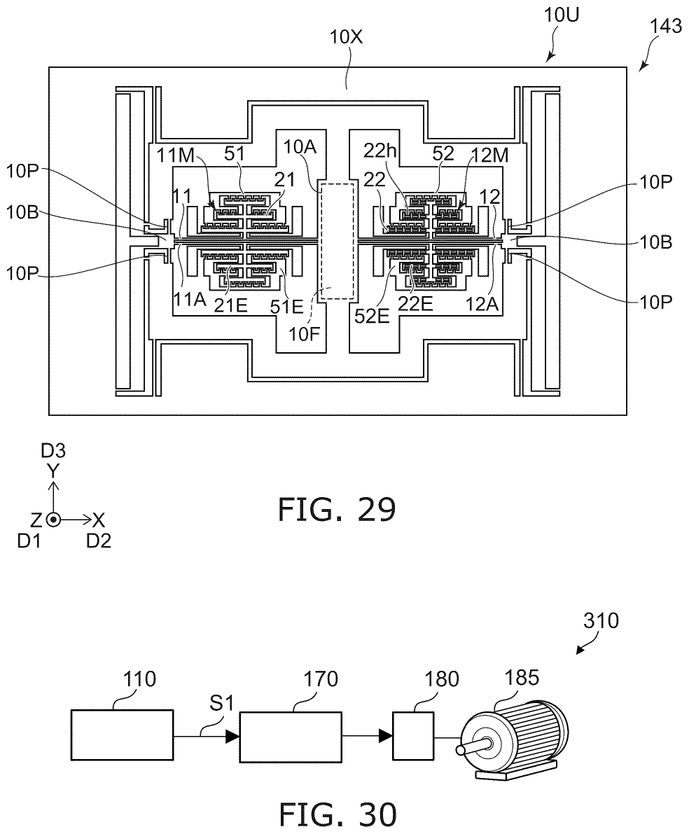

As shown in FIG. 29, in a sensor 143, the plurality of first movable electrodes 21 and the plurality of first other movable electrodes 21E are provided. The plurality of second movable electrodes 22 and the plurality of second other movable electrodes 22E are provided. The plurality of first other movable electrodes 21E are connected to the first other beam 11A. The plurality of second other movable electrodes 22E are connected to the second other beam 12A. The configuration of the sensor 143 except for this may be the same as the configuration of the sensor 142.

In the sensors 120 to 124, 130 to 133, and 140 to 143, the first movable structure 11M and the second movable structure 12M may satisfy at least one of the first to ninth conditions described above. In one example, the second movable electrode 22 included in the second movable structure 12M includes the second hole 22h. The first movable electrode 21 included in the first movable structure 11M does not include a first hole. Alternatively, the number or size of the second holes 22h is different from the number or size of the first holes.

### Second Embodiment

The second embodiment relates to an electronic device.

FIG. 30 is a schematic diagram illustrating an electronic device according to the second embodiment.

As shown in FIG. 30, an electronic device 310 according to the embodiment includes the sensor according to the first embodiment and a circuit controller 170. In the example of FIG. 30, the sensor 110 is drawn as the sensor. The circuit controller 170 is configured to control a circuit 180 based on a signal S1 obtained from the sensor. The circuit 180 is, for example, a control circuit of a driving device 185 or the like. According to the embodiment, for example, the circuit 180 for controlling the driving device 185 can be controlled with high accuracy.

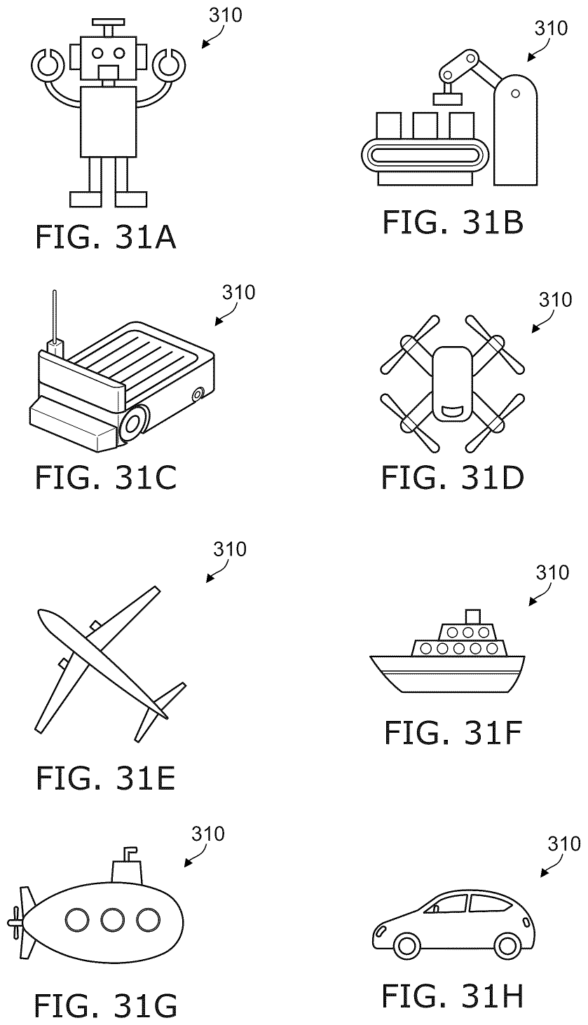

FIGS. 31A to 31H are schematic diagrams illustrating applications of the electronic device according to the embodiment. As shown in FIG. 31A, the electronic device 310 may be at least a part of a robot. As shown in FIG. 31B, the electronic device 310 may be at least a part of a work robot provided in a manufacturing factory or the like. As shown in FIG. 31C, the electronic device 310 may be at least a part of an automated guided vehicle such as in a factory. As shown in FIG. 31D, the electronic device 310 may be at least a part of a drone (unmanned aerial vehicle). As shown in FIG. 31E, the electronic device 310 may be at least a part of an airplane. As shown in FIG. 31F, the electronic device 310 may be at least a part of a vessel. As shown in FIG. 31G, the electronic device 310 may be at least a part of a submarine. As shown in FIG. 31H, the electronic device 310 may be at least a part of an automobile. The electronic device 310 may include, for example, at least one of a robot or a mobile object.

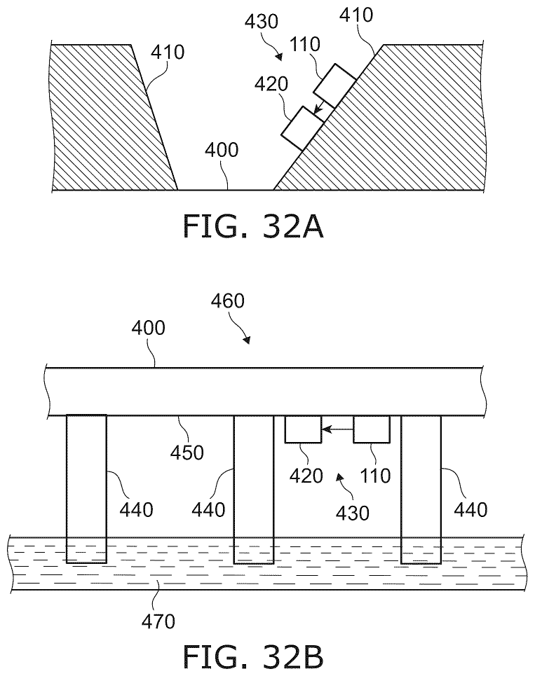

FIGS. 32A and 32B are schematic diagrams illustrating applications of the sensor according to the embodiment.

As shown in FIG. 32A, a sensor 430 according to the embodiment includes the sensor according to the first embodiment and a transmitter/receiver 420. In the example of FIG. 32A, the sensor 110 is drawn as the sensor. The transmitter/receiver 420 is configured to transmit the signal obtained from the sensor 110 by at least one of wireless or wired methods, for example. The sensor 430 is provided, for example, on a slope surface 410 such as a road 400. The sensor 430 may, for example, monitor conditions such as facilities (e.g., infrastructure). The sensor 430 may be, for example, a condition monitoring device.

For example, the sensor 430 detects changes in the state of the slope surface 410 of the road 400 with high accuracy. A change in the state of the slope surface 410 includes, for example, at least one of a change in tilt angle or a change in vibration state.

The signal (test result) obtained from the sensor 110 is transmitted by the transmitter/receiver 420. The condition of facilities (e.g., infrastructure) can be monitored, e.g., continuously.

As shown in FIG. 32B, the sensor 430 is provided on a part of a bridge 460, for example. The bridge 460 is provided over a river 470. For example, the bridge 460 includes at least one of main girder 450 and a bridge pier 440. The sensor 430 is provided on at least one of the main girder 450 and the bridge pier 440. For example, the angle of at least one of the main girder 450 and the bridge pier 440 may change due to deterioration or the like. For example, in at least one of the main girder 450 and the bridge pier 440, the vibration state may change. The sensor 430 detects these changes with high accuracy. A detection result can be transmitted to an arbitrary place by the transmitter/receiver 420. Anomalies can be effectively detected.

The embodiments include the following Technical proposals:

### (Technical Proposal 1)

A sensor, comprising:
a base; and
an element section,
the element section including:
   a first fixed portion fixed to the base,
   a first fixed electrode fixed to the base, and
   a first movable portion,
a first gap being provided between the base and the first movable portion,
the first movable portion including:
   a first movable base portion supported by the first fixed portion,
   a first other movable base portion connected to the first movable base portion, and
   a first movable structure,
the first movable structure including:
   a first beam,
   a first movable electrode, and
   a first connecting portion,
the first beam including a first beam portion, a first other beam portion, and a first intermediate beam portion between the first beam portion and the first other beam portion,
a second direction from the first beam portion to the first other beam portion crossing a first direction from the base to the first fixed portion,
the first beam portion being connected to the first movable base portion,
the first other beam portion being connected to the first other movable base portion,
a third direction from the first beam to the first movable electrode crossing a plane including the first direction and the second direction,
the first connecting portion connecting the first movable electrode to the first intermediate beam portion,
the first movable electrode including a first movable electrode base portion and a plurality of first movable protruding portions connected to the first movable electrode base portion, the plurality of first movable protruding portions being arranged along the second direction,
the first fixed electrode including a first fixed electrode base portion and a plurality of first fixed protruding portions connected to the first fixed electrode base portion, the plurality of first fixed protruding portion being arranged along the second direction,
the plurality of first movable protruding portions meshing with the plurality of first fixed protruding portions in a comb-teeth shape,
the plurality of first movable protruding portions including a first movable end protruding portions, a first movable other end protruding portion, and a plurality of first movable intermediate protruding portions,
the first movable end protruding portion being one end in the second direction among the plurality of first movable protruding portions,
the first movable other end protruding portion being another end in the second direction among the plurality of first movable protruding portions,
the plurality of first movable intermediate protruding portions being between the first movable end protruding portion and the first movable other end protruding portion,
a first movable end protruding portion width of the first movable end protruding portion along the second direction being the same as a first movable other end protruding portion width of the first movable other end protruding portion along the second direction.

### (Technical Proposal 2)

The sensor according to Technical proposal 1, wherein the plurality of first fixed protruding portions are between the first movable end protruding portion and the first movable other end protruding portion,
the first movable end protruding portion width is larger than a first movable intermediate protruding portion width along the second direction of each of the plurality of first movable intermediate protruding portions, and
the first movable other end protruding portion width is larger than the first movable intermediate protruding portion width.

### (Technical Proposal 3)

The sensor according to Technical proposal 1 or 2, wherein
the first movable electrode is line symmetrical with respect to a first line, and
the first line passes through the first intermediate beam portion and is along the third direction.

### (Technical Proposal 4)

The sensor according to any one of Technical proposals 1-3, wherein
the first intermediate beam portion is a center of the first beam in the second direction.

### (Technical Proposal 5)

The sensor according to Technical proposal 2, wherein
the first movable end protruding portion width is a width of the first movable end protruding portion along the second direction at a center of the first movable end protruding portion in the third direction,
the first movable other end protruding portion width is a width of the first movable other end protruding portion along the second direction at a center of the first movable other end protruding portion in the third direction, and
the first movable intermediate protruding portion width is a width along the second direction of one of the plurality of first movable intermediate protruding portions at a center in the third direction of the one of the plurality of first movable intermediate protruding portions.

### (Technical Proposal 6)

The sensor according to Technical proposal 5, wherein
the first movable intermediate protruding portion width decreases as a distance from the first movable electrode base portion increases, and
a width along the second direction of one of the plurality of first fixed protruding portions decreases as a distance from the first fixed electrode base portion increases.

### (Technical Proposal 7)

The sensor according to Technical proposal 1, wherein
the plurality of first fixed protruding portions include a first fixed end protruding portion, a first fixed other end protruding portion, and a plurality of first fixed intermediate protruding portion,
the first fixed end protruding portion is one end in the second direction among the plurality of first fixed protruding portions,
the first fixed other end protruding portion is another end in the second direction among the plurality of first fixed protruding portions,
the plurality of first fixed intermediate protruding portions are between the first fixed end protruding portion and the first fixed other end protruding portion, and
a first fixed end protruding portion width along the second direction of the first fixed end protruding portion is the same as a first fixed other end protruding portion width along the second direction of first fixed other end protruding portion.

### (Technical Proposal 8)

The sensor according to Technical proposal 7, wherein
the plurality of first movable protruding portions are between the first fixed end protruding portion and the first fixed other end protruding portion,
the first fixed end protruding portion width is larger than a first fixed intermediate protruding portion width along the second direction of each of the plurality of first fixed intermediate protruding portions, and
the first fixed other end protruding portion width is larger than the first fixed intermediate protruding portion width.

### (Technical Proposal 9)

The sensor according to Technical proposal 7 or 8, wherein
the first movable electrode is line symmetrical with respect to a first line, and
the first line passes through the first intermediate beam portion and is along the third direction.

### (Technical Proposal 10)

The sensor according to any one of Technical proposals 7-9, wherein
the first intermediate beam portion is a center of the first beam in the second direction.

### (Technical Proposal 11)

The sensor according to Technical proposal 8, wherein
the first fixed end protruding portion width is a width of the first fixed end protruding portion along the second direction at a center of the first fixed end protruding portion in the third direction,
the first fixed other end protruding portion width is a width of the first fixed other end protruding portion along the second direction at a center of the first fixed other end protruding portion in the third direction, and
the first fixed intermediate protruding portion width is a width along the second direction of one of the plurality of first fixed intermediate protruding portions at a center in the third direction of one of the plurality of first fixed intermediate protruding portions.

### (Technical Proposal 12)

The sensor according to Technical proposal 11, wherein
the first fixed intermediate protruding portion width decreases as a distance from the first fixed electrode base portion increases, and
a width along the second direction of one of the plurality of first movable protruding portions decreases as a distance from the first movable electrode base portion increases.

### (Technical Proposal 13)

The sensor according to any one of Technical proposals 1-12, wherein
a first distance along the third direction between one of the plurality of first movable protruding portions and the first fixed electrode base portion is not less than 0.79 times a second distance along the second direction between the one of the plurality of first movable protruding portions and one of the plurality of first fixed protruding portions, and
other of the plurality of first fixed protruding portions is not provided between the one of the plurality of first movable protruding portions and the one of the plurality of first fixed protruding portions.

### (Technical Proposal 14)

The sensor according to any one of Technical proposals 1-13, further comprising:
a controller,
the controller being configured to detect a signal generated between the first movable electrode and the first fixed electrode.

### (Technical Proposal 15)

The sensor according to any one of Technical proposals 1-14, wherein
the first movable structure includes a plurality of the first movable electrodes,
the first connecting portion connects the plurality of first movable electrodes to the first intermediate beam portion,
one of the plurality of first movable electrodes is provided between another one of the plurality of first movable electrodes and the first beam, and
a length along the second direction of the one of the plurality of first movable electrodes is longer than a length along the second direction of the other one of the plurality of first movable electrodes.

### (Technical Proposal 16)

The sensor according to any one of Technical proposals 1-15, wherein
the element section further includes a second fixed electrode fixed to the base,
the first movable portion further includes a second movable structure,
the second movable structure includes:
   a second beam,
   a second movable electrode, and
   a second connecting portion,
the second beam includes a second beam portion, a second other beam portion, and a second intermediate beam portion between the second beam portion and the second other beam portion,
a direction from the second beam portion to the second other beam portion is along the second direction,
the second beam portion is connected to the first movable base portion,
the second other beam portion is connected to the first other movable base portion,
the second connecting portion connects the second movable electrode to the second intermediate beam portion,
the second movable electrode includes a second movable electrode base portion and a plurality of second movable protruding portions connected to the second movable electrode base portion and arranged along the second direction,
the second fixed electrode includes a second fixed electrode base portion and a plurality of second fixed protruding portions connected to the second fixed electrode base portion and arranged along the second direction, and
the plurality of second movable protruding portions mesh with the plurality of second fixed protruding portions in a comb shape.

### (Technical Proposal 17)

The sensor according to any one of Technical proposals 1-16, wherein
the element section further includes a first opposing fixed electrode fixed to the base, and
at least a part of the first movable electrode is between the first opposing fixed electrode and the first fixed electrode in the third direction.

### (Technical Proposal 18)

The sensor according to any one of Technical proposals 1-16, wherein
the element section further includes a first opposing fixed electrode fixed to the base,
at least a part of the first movable electrode is between the first opposing fixed electrode and the first fixed electrode in the third direction,
the first movable electrode further includes a plurality of first opposing movable protruding portions connected to the first movable electrode base portion and arranged along the second direction,
the first movable electrode base portion is provided between the plurality of first opposing movable protruding portions and the plurality of first movable protruding portions,
the first opposing fixed electrode includes a first opposing fixed electrode base portion and a plurality of first opposing fixed protruding portions connected to the first opposing fixed electrode base portion and arranged along the second direction, and
the plurality of first opposing movable protruding portions mesh with the plurality of first opposing fixed protruding portions in a comb-teeth shape.

### (Technical Proposal 19)

The sensor according to Technical proposal 16, wherein
the first movable electrode and the second movable electrode satisfy at least one of a first condition, a second condition, a third condition, a fourth condition, a fifth condition, a sixth condition, a seventh condition, an eighth condition, or a ninth condition,
in the first condition, a second mass of the second movable electrode is different from a first mass of the first movable electrode,
in the second condition, a second thickness of the second movable electrode along the first direction is different from a first thickness of the first movable electrode along the first direction,
in the third condition, at least a part of a second material included in the second movable electrode is different from at least a part of a first material included in the first movable electrode,
in the fourth condition, the second movable electrode includes a second hole, and the first movable electrode does not include a first hole,
in the fifth condition, a second size of the second hole included in the second movable electrode is different from a first size of the first hole included in the first movable electrode,
in the sixth condition, a second density of the second holes is different from a first density of the first holes,
in the seventh condition, a second number of the second holes is different from a first number of the first holes,
in the eighth condition, a second shape of the second hole is different from a first shape of the first hole, and
in the ninth condition, a second layer structure of the second movable electrode is different from a first layer structure of the first movable electrode.

### (Technical Proposal 20)

An electronic device, comprising:
the sensor according to any one of Technical proposals 1-19;
a circuit controller configured to control a circuit based on a signal obtained from the sensor.

### (Technical Proposal 21)

The sensor according to any one of Technical proposals 1-19, wherein
the first movable portion further includes a first movable connecting portion,
the first movable connecting portion is provided between the first movable base portion and the first other movable base portion,
the first movable connecting portion is connected to the first other movable base portion and the first movable base portion,
a width of the first movable connecting portion in a crossing direction crossing a direction from the first movable base portion to the first other movable base portion is narrower than a width of the first movable base portion in the crossing direction and narrower than a width of the first other movable base portion in the crossing direction.

### (Technical Proposal 22)

The sensor according to any one of Technical proposals 1-15, wherein
the element section further includes a second fixed electrode fixed to the base,
the first movable portion further includes a second movable structure,
the second movable structure includes:
   a second movable electrode, and
   a second connecting portion,
the second connecting portion connects the second movable electrode to the first intermediate beam portion,
the first beam is provided between the second movable electrode and the first movable electrode in the third direction,
the second movable electrode includes a second movable electrode base portion, and a plurality of second movable protruding portions connected to the second movable electrode base portion and arranged along the second direction,
the second fixed electrode includes a second fixed electrode base portion, and a plurality of second fixed protruding portions connected to the second fixed electrode base portion and arranged along the second direction, and
the plurality of second movable protruding portions mesh with the plurality of second fixed protruding portions in a comb shape.

### (Technical Proposal 23)

The sensor according to Technical proposals 22, wherein
the first movable electrode and the second movable electrode satisfy at least one of a first condition, a second condition, a third condition, a fourth condition, a fifth condition, a sixth condition, a seventh condition, an eighth condition, or a ninth condition,
in the first condition, a second mass of the second movable electrode is different from a first mass of the first movable electrode,
in the second condition, a second thickness of the second movable electrode along the first direction is different from a first thickness of the first movable electrode along the first direction,
in the third condition, at least a part of a second material included in the second movable electrode is different from at least a part of a first material included in the first movable electrode,
in the fourth condition, the second movable electrode includes a second hole, and the first movable electrode does not include a first hole,
in the fifth condition, a second size of the second hole included in the second movable electrode is different from a first size of the first hole included in the first movable electrode,
in the sixth condition, a second density of the second holes is different from a first density of the first holes,
in the seventh condition, a second number of the second holes is different from a first number of the first holes,
in the eighth condition, a second shape of the second hole is different from a first shape of the first hole, and
in the ninth condition, a second layer structure of the second movable electrode is different from a first layer structure of the first movable electrode.

According to the embodiments, a sensor and an electronic device that can obtain stable characteristics are provided.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in sensors such as bases, element sections, fixed portions, controllers, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors and electronic devices practicable by an appropriate design modification by one skilled in the art based on the sensors and the electronic devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sensor, comprising:
a base; and
an element section,
the element section including:
a first fixed portion fixed to the base,
a first fixed electrode fixed to the base, and
a first movable portion,
a first gap being provided between the base and the first movable portion,
the first movable portion including:
a first movable base portion supported by the first fixed portion,
a first other movable base portion connected to the first movable base portion, and
a first movable structure,
the first movable structure including:
a first beam,
a first movable electrode, and
a first connecting portion,
the first beam including a first beam portion, a first other beam portion, and a first intermediate beam portion between the first beam portion and the first other beam portion,
a second direction from the first beam portion to the first other beam portion crossing a first direction from the base to the first fixed portion,
the first beam portion being connected to the first movable base portion,
the first other beam portion being connected to the first other movable base portion,
a third direction from the first beam to the first movable electrode crossing a plane including the first direction and the second direction,
the first connecting portion connecting the first movable electrode to the first intermediate beam portion,
the first movable electrode including a first movable electrode base portion and a plurality of first movable protruding portions connected to the first movable electrode base portion, the plurality of first movable protruding portions being arranged along the second direction,
the first fixed electrode including a first fixed electrode base portion and a plurality of first fixed protruding portions connected to the first fixed electrode base portion, the plurality of first fixed protruding portion being arranged along the second direction,
the plurality of first movable protruding portions meshing with the plurality of first fixed protruding portions in a comb-teeth shape,
the plurality of first movable protruding portions including a first movable end protruding portions, a first movable other end protruding portion, and a plurality of first movable intermediate protruding portions,
the first movable end protruding portion being one end in the second direction among the plurality of first movable protruding portions,
the first movable other end protruding portion being another end in the second direction among the plurality of first movable protruding portions,
the plurality of first movable intermediate protruding portions being between the first movable end protruding portion and the first movable other end protruding portion,
a first movable end protruding portion width of the first movable end protruding portion along the second direction being the same as a first movable other end protruding portion width of the first movable other end protruding portion along the second direction.

2. The sensor according to claim 1, wherein
the plurality of first fixed protruding portions are between the first movable end protruding portion and the first movable other end protruding portion,
the first movable end protruding portion width is larger than a first movable intermediate protruding portion width along the second direction of each of the plurality of first movable intermediate protruding portions, and
the first movable other end protruding portion width is larger than the first movable intermediate protruding portion width.

3. The sensor according to claim 1, wherein
the first movable electrode is line symmetrical with respect to a first line, and
the first line passes through the first intermediate beam portion and is along the third direction.

4. The sensor according to claim 1, wherein
the first intermediate beam portion is a center of the first beam in the second direction.

5. The sensor according to claim 2, wherein
the first movable end protruding portion width is a width of the first movable end protruding portion along the second direction at a center of the first movable end protruding portion in the third direction,
the first movable other end protruding portion width is a width of the first movable other end protruding portion along the second direction at a center of the first movable other end protruding portion in the third direction, and
the first movable intermediate protruding portion width is a width along the second direction of one of the plurality of first movable intermediate protruding portions at a center in the third direction of the one of the plurality of first movable intermediate protruding portions.

6. The sensor according to claim 5, wherein
the first movable intermediate protruding portion width decreases as a distance from the first movable electrode base portion increases, and
a width along the second direction of one of the plurality of first fixed protruding portions decreases as a distance from the first fixed electrode base portion increases.

7. The sensor according to claim 1, wherein
the plurality of first fixed protruding portions include a first fixed end protruding portion, a first fixed other end protruding portion, and a plurality of first fixed intermediate protruding portion,
the first fixed end protruding portion is one end in the second direction among the plurality of first fixed protruding portions,
the first fixed other end protruding portion is another end in the second direction among the plurality of first fixed protruding portions,
the plurality of first fixed intermediate protruding portions are between the first fixed end protruding portion and the first fixed other end protruding portion, and
a first fixed end protruding portion width along the second direction of the first fixed end protruding portion is the same as a first fixed other end protruding portion width along the second direction of first fixed other end protruding portion.

8. The sensor according to claim 7, wherein
the plurality of first movable protruding portions are between the first fixed end protruding portion and the first fixed other end protruding portion,
the first fixed end protruding portion width is larger than a first fixed intermediate protruding portion width along the second direction of each of the plurality of first fixed intermediate protruding portions, and
the first fixed other end protruding portion width is larger than the first fixed intermediate protruding portion width.

9. The sensor according to claim 7, wherein
the first movable electrode is line symmetrical with respect to a first line, and
the first line passes through the first intermediate beam portion and is along the third direction.

10. The sensor according to claim 7, wherein
the first intermediate beam portion is a center of the first beam in the second direction.

11. The sensor according to claim 8, wherein
the first fixed end protruding portion width is a width of the first fixed end protruding portion along the second direction at a center of the first fixed end protruding portion in the third direction,
the first fixed other end protruding portion width is a width of the first fixed other end protruding portion along the second direction at a center of the first fixed other end protruding portion in the third direction, and
the first fixed intermediate protruding portion width is a width along the second direction of one of the plurality of first fixed intermediate protruding portions at a center in the third direction of one of the plurality of first fixed intermediate protruding portions.

12. The sensor according to claim 11, wherein
the first fixed intermediate protruding portion width decreases as a distance from the first fixed electrode base portion increases, and
a width along the second direction of one of the plurality of first movable protruding portions decreases as a distance from the first movable electrode base portion increases.

13. The sensor according to claim 1, wherein
a first distance along the third direction between one of the plurality of first movable protruding portions and the first fixed electrode base portion is not less than 0.79 times a second distance along the second direction between the one of the plurality of first movable protruding portions and one of the plurality of first fixed protruding portions, and
other of the plurality of first fixed protruding portions is not provided between the one of the plurality of first movable protruding portions and the one of the plurality of first fixed protruding portions.

14. The sensor according to claim 1, further comprising:
a controller,
the controller being configured to detect a signal generated between the first movable electrode and the first fixed electrode.

15. The sensor according to claim 1, wherein
the first movable structure includes a plurality of the first movable electrodes,
the first connecting portion connects the plurality of first movable electrodes to the first intermediate beam portion,
one of the plurality of first movable electrodes is provided between another one of the plurality of first movable electrodes and the first beam, and
a length along the second direction of the one of the plurality of first movable electrodes is longer than a length along the second direction of the other one of the plurality of first movable electrodes.

16. The sensor according to claim 1, wherein
the element section further includes a second fixed electrode fixed to the base,
the first movable portion further includes a second movable structure,
the second movable structure includes:
a second beam,
a second movable electrode, and
a second connecting portion,
the second beam includes a second beam portion, a second other beam portion, and a second intermediate beam portion between the second beam portion and the second other beam portion,
a direction from the second beam portion to the second other beam portion is along the second direction,
the second beam portion is connected to the first movable base portion,
the second other beam portion is connected to the first other movable base portion,
the second connecting portion connects the second movable electrode to the second intermediate beam portion,
the second movable electrode includes a second movable electrode base portion and a plurality of second movable protruding portions connected to the second movable electrode base portion and arranged along the second direction,
the second fixed electrode includes a second fixed electrode base portion and a plurality of second fixed protruding portions connected to the second fixed electrode base portion and arranged along the second direction, and
the plurality of second movable protruding portions mesh with the plurality of second fixed protruding portions in a comb shape.

17. The sensor according to claim 1, wherein
the element section further includes a first opposing fixed electrode fixed to the base, and
at least a part of the first movable electrode is between the first opposing fixed electrode and the first fixed electrode in the third direction.

18. The sensor according to claim 1, wherein
the element section further includes a first opposing fixed electrode fixed to the base,
at least a part of the first movable electrode is between the first opposing fixed electrode and the first fixed electrode in the third direction,
the first movable electrode further includes a plurality of first opposing movable protruding portions connected to the first movable electrode base portion and arranged along the second direction,
the first movable electrode base portion is provided between the plurality of first opposing movable protruding portions and the plurality of first movable protruding portions,
the first opposing fixed electrode includes a first opposing fixed electrode base portion and a plurality of first opposing fixed protruding portions connected to the first opposing fixed electrode base portion and arranged along the second direction, and
the plurality of first opposing movable protruding portions mesh with the plurality of first opposing fixed protruding portions in a comb-teeth shape.

19. The sensor according to claim 16, wherein
the first movable electrode and the second movable electrode satisfy at least one of a first condition, a second condition, a third condition, a fourth condition, a fifth condition, a sixth condition, a seventh condition, an eighth condition, or a ninth condition,
in the first condition, a second mass of the second movable electrode is different from a first mass of the first movable electrode,
in the second condition, a second thickness of the second movable electrode along the first direction is different from a first thickness of the first movable electrode along the first direction,
in the third condition, at least a part of a second material included in the second movable electrode is different from at least a part of a first material included in the first movable electrode,
in the fourth condition, the second movable electrode includes a second hole, and the first movable electrode does not include a first hole,
in the fifth condition, a second size of the second hole included in the second movable electrode is different from a first size of the first hole included in the first movable electrode,
in the sixth condition, a second density of the second holes is different from a first density of the first holes,
in the seventh condition, a second number of the second holes is different from a first number of the first holes,
in the eighth condition, a second shape of the second hole is different from a first shape of the first hole, and
in the ninth condition, a second layer structure of the second movable electrode is different from a first layer structure of the first movable electrode.

20. An electronic device, comprising:
the sensor according to claim 1;
a circuit controller configured to control a circuit based on a signal obtained from the sensor.
